(19) United States
(12) Patent Application Publication
(10) Pub. No.: US 2026/0105643 A1
(43) Pub. Date: Apr. 16, 2026

(54) METHOD, APPARATUS AND SYSTEM FOR ENCODING AND DECODING A TENSOR

(71) Applicant: CANON KABUSHIKI KAISHA, Tokyo (JP)

(72) Inventors: Thi Hong Nhung NGUYEN, Gladesville (AU); Christopher James ROSEWARNE, Concord (AU)

(21) Appl. No.: 19/114,428

(22) PCT Filed: Jul. 28, 2023
(86) PCT No.: PCT/AU2023/050700

§ 371 Date: Mar. 21, 2025

(30) Foreign Application Priority Data
Oct. 13, 2022 (AU) 2022252785

(51) Int. Cl. G06T 9/00; G06N 3/0464; G06N 3/048

(52) U.S. Cl. CPC G06T 9/002; G06N 3/0464; G06N 3/048

(57) ABSTRACT

A system and method of encoding a tensor related to image data into a bitstream. The method comprises acquiring a first tensor for the image data, the first tensor derived using a portion of a neural network, the neural network including at least a plurality of layers of a first type, each layer of the first type having at least a convolutional module and a batch-normalization module, wherein the first tensor corresponds to a tensor for which the convolutional module of one of the plurality of layers of the first type has been performed but for which the batch-normalization module of the one of the plurality of layers of the first type has not been performed. The method further comprises performing predetermined processing on the first tensor to derive a second tensor, and encoding the second tensor into the bitstream.

### REFERENCE OT RELATED APPLICATION(S)

This application claims the benefit under 35 U.S. C. § 119 of the filing date of Australian Patent Application No. 2022252785, filed 13 Oct. 2022, hereby incorporated by reference in its entirety as if fully set forth herein.

### TECHNICAL FIELD

The present invention relates generally to digital video signal processing and, in particular, to a method, apparatus and system for encoding and decoding tensors from a convolutional neural network. The present invention also relates to a computer program product including a computer readable medium having recorded thereon a computer program for encoding and decoding tensors from a convolutional neural network using video compression technology.

### BACKGROUND

Convolution neural networks (CNNs) are an emerging technology addressing, among other things, use cases involving machine vision such as object detection, instance segmentation, object tracking, human pose estimation and action recognition. Applications for CNNs can involve use of ‘edge devices’ with sensors and some processing capability, coupled to application servers as part of a ‘cloud’. CNNs can require relatively high computational complexity, more than can typically be afforded either in computing capacity or power consumption by an edge device. Executing a CNN in a distributed manner has emerged as one solution to running leading edge networks using limited capability edge devices. In other words, distributed processing allows legacy edge devices to still provide the capability of leading edge CNNs by distributing processing between the edge device and external processing means, such as cloud servers.

CNNs typically include many layers, such as convolution layers and fully connected layers, with data passing from one layer to the next in the form of ‘tensors’. Splitting a network across different devices introduces a need to compress the intermediate tensor data that passes from one layer to the next within a CNN, such compression may be referred to as ‘feature compression’, as the intermediate tensor data is often termed ‘features’ or ‘feature maps’ and represents a partially processed form of input such as an image frame or video frame. International Organisation for Standardisation/International Electrotechnical Commission Joint Technical Committee 1/Subcommittee 29/ Working Groups 2-8 (ISO/IEC JTC1/SC29/WG2-8), also known as the “Moving Picture Experts Group” (MPEG) are tasked with studying compression technology relating to video. WG2 ‘MPEG Technical Requirements’ has established a ‘Video Compression for Machines’ (VCM) ad-hoc group, mandated to study video compression for machine consumption and feature compression. The feature compression mandate is in an exploratory phase with a ‘Call for Evidence’ (CfE) anticipated to be issued, to solicit technology that can significantly outperform feature compression results achieved using state-of-the-art standardised technology.

CNNs require weights for each of the layers to be determined in a training stage, where a very large amount of training data is passed through the CNN and a determined result is compared to ground truth associated with the training data. A process for updating network weights, such as stochastic gradient descent, is applied to iteratively refine the network weights until the network performs at a desired level of accuracy. Where a convolution stage has a ‘stride’ greater than one, an output tensor from the convolution has a lower spatial resolution than a corresponding input tensor. Pooling operations result in an output tensor having smaller dimensions than the input tensor. One example of a pooling operation is ‘max pooling’ (or ‘Maxpool’), which reduces the spatial size of the output tensor compared to the input tensor. Max pooling produces an output tensor by dividing the input tensor into groups of data samples (e.g., a 2×2 group of data samples), and from each group selecting a maximum value as output for a corresponding value in the output tensor. The process of executing a CNN with an input and progressively transforming the input into an output is commonly referred to as ‘inferencing’.

Generally, a tensor has four dimensions, namely: batch, channels, height and width. The first dimension, ‘batch’, of size ‘one’ when inferencing on video data indicates that one frame is passed through a CNN at a time. When training a network, the value of the batch dimension may be increased so that multiple frames are passed through the network before the network weights are updated, according to a predetermined ‘batch size’. A multi-frame video may be passed through as a single tensor with the batch dimension increased in size according to the number of frames of a given video. However, for practical considerations relating to memory consumption and access, inferencing on video data is typically performed on a frame-wise basis. The ‘channels’ dimension indicates the number of concurrent ‘feature maps’ for a given tensor and the height and width dimensions indicate the size of the feature maps at the particular stage of the CNN. Channel count varies through a CNN according to the network architecture. Feature map size also varies, depending on subsampling occurring in specific network layers.

Input to the first layer of a CNN is a batch of one or more images, for example, a single image or video frame, typically resized for compatibility with the dimensionality of the tensor input to the first layer. It is also possible to supply images or video frames in batches of size larger than one. The dimensionality of tensors is dependent on the CNN architecture, generally having some dimensions relating to input width and height and a further ‘channel’ dimension.

Slicing, or reducing a tensor to a collection of two-dimensional arrays, a tensor based on the channel dimension results in a set of two-dimensional ‘feature maps’, so-called because each slice of the tensor has some relationship to the corresponding input image, capturing properties such as various edge types. At layers further from the input to the network, the property can be more abstract. The ‘task performance’ of a CNN is measured by comparing the result of the CNN in performing a task using specific input with a provided ground truth, generally prepared by humans and deemed to indicate a ‘correct’ result.

Once a network topology is decided, the network weights may be updated over time as more training data becomes available. The overall complexity of the CNN tends to be relatively high, with relatively large numbers of multiply-accumulate operations being performed and numerous intermediate tensors being written to and read from memory. In some applications, the CNN is implemented entirely in the ‘cloud’, resulting in a need for high and costly processing power. In other applications, the CNN is implemented in an edge device, such as a camera or mobile phone, resulting in less flexibility but a more distributed processing load. An emerging architecture involves splitting a network into portions, one of the portions run in an edge device and another portion run in the cloud. Such a distributed network architecture may be referred to as ‘collaborative intelligence’ and offers benefits such as re-using a partial result from a first portion of the network with several different second portions, perhaps each portion being optimised for a different task. Collaborative intelligence architectures introduce a need for efficient compression of tensor data, for transmission over a network such as a WAN. Intermediate CNN features may be compressed rather than the original video data, which may be referred to as ‘feature coding’. The feasibility of feature coding, in particular competitiveness of feature coding relative to video coding, often depends on two main factors: the size of the features relative to the size of the original video data; and the ability of the feature coder to find and exploit redundancies in the features and in the network.

Video compression standards can be used for feature compression, as described below. Various methods can be used to constrict or reduce the data being presented for compression. However, some methods used to constrict or reduce the data being presented for compression can result in a decrease in accuracy unsuitable for some tasks implemented by CNNs.

Feature compression may benefit from existing video compression standards, such as Versatile Video Coding (VVC), developed by the Joint Video Experts Team (JVET). VVC is anticipated to address ongoing demand for ever-higher compression performance, especially as video formats increase in capability (e.g., with higher resolution and higher frame rate) and to address increasing market demand for service delivery over WANs, where bandwidth costs are relatively high. VVC is implementable in contemporary silicon processes and offers an acceptable trade-off between achieved performance versus implementation cost. The implementation cost may be considered for example, in terms of one or more of silicon area, CPU processor load, memory utilisation and bandwidth. Part of the versatility of the VVC standard is in the wide selection of tools available for compressing video data, as well as the wide range of applications for which VVC is suitable. Other video compression standards, such as High Efficiency Video Coding (HEVC) and AV-1, may also be used for feature compression applications.

Video data includes a sequence of frames of image data, each frame including one or more colour channels. Generally, one primary colour channel and two secondary colour channels are needed. The primary colour channel is generally referred to as the ‘luma’ channel and the secondary colour channel(s) are generally referred to as the ‘chroma’ channels. Although video data is typically displayed in an RGB (red-green-blue) colour space, this colour space has a high degree of correlation between the three respective components. The video data representation seen by an encoder or a decoder is often using a colour space such as YCbCr. YCbCr concentrates luminance, mapped to ‘luma’ according to a transfer function, in a Y (primary) channel and chroma in Cb and Cr (secondary) channels. Due to the use of a decorrelated YCbCr signal, the statistics of the luma channel differ markedly from those of the chroma channels. A primary difference is that after quantisation, the chroma channels contain relatively few significant coefficients for a given block compared to the coefficients for a corresponding luma channel block. Moreover, the Cb and Cr channels may be sampled spatially at a lower rate (subsampled) compared to the luma channel, for example half horizontally and half vertically-known as a ‘4:2:0 chroma format’. The 4:2:0 chroma format is commonly used in ‘consumer’ applications, such as internet video streaming, broadcast television, and storage on Blu-Ray™ disks. When only luma samples are present, the resulting monochrome frames are said to use a “4:0:0 chroma format”.

The VVC standard specifies a ‘block based’ architecture, in which frames are firstly divided into a square array of regions known as ‘coding tree units’ (CTUs). CTUs generally occupy a relatively large area, such as 128×128 luma samples. Other possible CTU sizes when using the VVC standard are 32×32 and 64×64. However, CTUs at the right and bottom edge of each frame may be smaller in area, with implicit splitting occurring the ensure the CBs remain in the frame. Associated with each CTU is a ‘coding tree’ either for both the luma channel and the chroma channels (a ‘shared tree’) or a separate tree each for the luma channel and the chroma channels. A coding tree defines a decomposition of the area of the CTU into a set of blocks, also referred to as ‘coding blocks’ (CBs). When a shared tree is in use a single coding tree specifies blocks both for the luma channel and the chroma channels, in which case the collections of collocated coding blocks are referred to as ‘coding units’ (CUs) (i.e., each CU having a coding block for each colour channel). The CBs are processed for encoding or decoding in a particular order. As a consequence of the use of the 4:2:0 chroma format, a CTU with a luma coding tree for a 128×128 luma sample area has a corresponding chroma coding tree for a 64×64 chroma sample area, collocated with the 128×128 luma sample area. When a single coding tree is in use for the luma channel and the chroma channels, the collections of collocated blocks for a given area are generally referred to as ‘units’, for example, the above-mentioned CUs, as well as ‘prediction units’ (PUs), and ‘transform units’ (TUs). A single tree with CUs spanning the colour channels of 4:2:0 chroma format video data result in chroma blocks half the width and height of the corresponding luma blocks. When separate coding trees are used for a given area, the above-mentioned CBs, as well as ‘prediction blocks’ (PBs), and ‘transform blocks’(TBs) are used.

Notwithstanding the above distinction between ‘units’ and ‘blocks’, the term ‘block’ may be used as a general term for areas or regions of a frame for which operations are applied to all colour channels.

For each CU, a prediction unit (PU) of the contents (sample values) of the corresponding area of frame data is generated (a ‘prediction unit’). Further, a representation of the difference (or ‘spatial domain’ residual) between the prediction and the contents of the area as seen at input to the encoder is formed. The difference in each colour channel may be transformed and coded as a sequence of residual coefficients, forming one or more TUs for a given CU. The applied transform may be a Discrete Cosine Transform (DCT) or other transform, applied to each block of residual values. The transform is applied separably, (i.e., the two-dimensional transform is performed in two passes). The block is firstly transformed by applying a one-dimensional transform to each row of samples in the block. Then, the partial result is transformed by applying a one-dimensional transform to each column of the partial result to produce a final block of transform coefficients that substantially decorrelates the residual samples. Transforms of various sizes are supported by the VVC standard, including transforms of rectangular-shaped blocks, with each side dimension being a power of two. Transform coefficients are quantised for entropy encoding into a bitstream.

VVC features intra-frame prediction and inter-frame prediction. Intra-frame prediction involves the use of previously processed samples in a frame being used to generate a prediction of a current block of data samples in the frame. Inter-frame prediction involves generating a prediction of a current block of samples in a frame using a block of samples obtained from a previously decoded frame. The block of samples obtained from a previously decoded frame is offset from the spatial location of the current block according to a motion vector, which often has filtering applied. Intra-frame prediction blocks can be (i) a uniform sample value (“DC intra prediction”), (ii) a plane having an offset and horizontal and vertical gradient (“planar intra prediction”), (iii) a population of the block with neighbouring samples applied in a particular direction (“angular intra prediction”) or (iv) the result of a matrix multiplication using neighbouring samples and selected matrix coefficients. Further discrepancy between a predicted block and the corresponding input samples may be corrected to an extent by encoding a ‘residual’ into the bitstream. The residual is generally transformed from the spatial domain to the frequency domain to form residual coefficients in a ‘primary transform’ domain. The residual coefficients may be further transformed by application of a ‘secondary transform’ to produce residual coefficients in a ‘secondary transform domain’. Residual coefficients are quantised according to a quantisation parameter, resulting in a loss of accuracy of the reconstruction of the samples produced at the decoder but with a reduction in bitrate in the bitstream. Sequences of pictures may be encoded according to a specified structure of pictures using intra-prediction and pictures using intra-or inter-prediction, and specified dependencies on preceding pictures in coding order, which may differ from display or delivery order. A ‘random access’ configuration results in periodic intra-pictures, forming entry points at which a decoder and commence decoding a bitstream. Other pictures in a random-access configuration generally use inter-prediction to predict content from pictures preceding and following a current picture in display or delivery order, according to a hierarchical structure of specified depth. The use of pictures after a current picture in display order for predicting a current picture requires a degree of picture buffering and delay between the decoding of a given picture and the display (and removal from the buffer) of the given picture.

### SUMMARY

It is an object of the present invention to substantially overcome, or at least ameliorate, one or more disadvantages of existing arrangements.

One aspect of the present disclosure provides a method of encoding a tensor related to image data into a bitstream, the method comprising: acquiring a first tensor for the image data, the first tensor derived using a portion of a neural network, the neural network including at least a plurality of layers of a first type, each layer of the first type having at least a convolutional module and a batch-normalization module, wherein the first tensor corresponds to a tensor for which the convolutional module of one of the plurality of layers of the first type has been performed but for which the batch-normalization module of the one of the plurality of layers of the first type has not been performed; performing predetermined processing on the first tensor to derive a second tensor, wherein the number of dimensions of a data structure of the first tensors is larger than the number of dimensions of a data structure of the second tensor; and encoding the second tensor into the bitstream.

Another aspect of the present disclosure provides a method of deriving a tensor based on a bitstream related to image data, the derived tensor being for processing using a portion of a neural network, the method comprising: decoding a tensor from the bitstream; and performing predetermined processing on the decoded tensor to generate the derived tensor, a number of dimensions of a data structure of the derived tensor being larger than a number of dimensions of a data structure of the decoded tensor; wherein the neural network includes at least a plurality of layers of a first type, each layer of the first type having at least a convolutional module and a batch-normalization module, and the derived tensor corresponds to a tensor in which a processing of the convolutional module of one of the plurality of layers of the first type has been performed but a processing of the batch-normalization module of the one of the plurality of layers of the first type has not been performed.

Another aspect of the present disclosure provides a non-transitory computer-readable storage medium which stores a program for executing a method of encoding a tensor related to image data into a bitstream, the method comprising: acquiring a first tensor for the image data, the first tensor derived using a portion of a neural network, the neural network including at least a plurality of layers of a first type, a layer of the first type having at least a convolutional module and a batch-normalization module, wherein the first tensor corresponds to a tensor for which the convolutional module of one of the plurality of layers of the first type has been performed but for which the batch-normalization module of the one of the plurality of layers of the first type has not been performed; performing predetermined processing on the first tensor to derive a second tensor, wherein the number of dimensions of a data structure of the first tensors is larger than the number of dimensions of a data structure of the second tensor; and encoding the second tensor into the bitstream.

Another aspect of the present disclosure provides an encoder configured to: acquire a first tensor related to image data, the first tensor derived using a portion of a neural network, the neural network including at least a plurality of layers of a first type, a layer of the first type having at least a convolutional module and a batch-normalization module, wherein the first tensor corresponds to a tensor for which the convolutional module of one of the plurality of layers of the first type has been performed but for which the batch-normalization module of the one of the plurality of layers of the first type has not been performed; perform predetermined processing on the first tensor to derive a second tensor, wherein the number of dimensions of a data structure of the first tensors is larger than the number of dimensions of a data structure of the second tensor; and encode the second tensor into the bitstream.

Another aspect of the present disclosure provides a system comprising: a memory; and a processor, wherein the processor is configured to execute code stored on the memory for implementing a method of encoding a tensor related to image data into a bitstream, the method comprising: acquiring a first tensor for the image data, the first tensor derived using a portion of a neural network, the neural network including at least a plurality of layers of a first type, a layer of the first type having at least a convolutional module and a batch-normalization module, wherein the first tensor corresponds to a tensor for which the convolutional module of one of the plurality of layers of the first type has been performed but for which the batch-normalization module of the one of the plurality of layers of the first type has not been performed; performing predetermined processing on the first tensor to derive a second tensor, wherein the number of dimensions of a data structure of the first tensors is larger than the number of dimensions of a data structure of the second tensor; and encoding the second tensor into the bitstream.

Another aspect of the present disclosure provides a non-transitory computer-readable storage medium which stores a program for executing a method of deriving a tensor based on a bitstream related to image data, the derived tensor being for processing using a portion of a neural network, the method comprising: decoding a tensor from the bitstream; and performing predetermined processing on the decoded tensor to generate the derived tensor, a number of dimensions of a data structure of the derived tensor being larger than a number of dimensions of a data structure of the decoded tensor; wherein the neural network includes at least a plurality of layers of a first type, ah layer of the first type having at least a convolutional module and a batch-normalization module, and the derived tensor corresponds to a tensor in which a processing of the convolutional module of one of the plurality of layers of the first type has been performed but a processing of the batch-normalization module of the one of the plurality of layers of the first type has not been performed.

Another aspect of the present disclosure provides a decoder configured to: decode a tensor from a bitstream related to image data; and perform predetermined processing on the decoded tensor to generate a derived tensor for processing using a portion of a neural network, a number of dimensions of a data structure of the derived tensor being larger than a number of dimensions of a data structure of the decoded tensor; wherein the neural network includes at least a plurality of layers of a first type, a layer of the first type having at least a convolutional module and a batch-normalization module, and the derived tensor corresponds to a tensor in which a processing of the convolutional module of one of the plurality of layers of the first type has been performed but a processing of the batch-normalization module of the one of the plurality of layers of the first type has not been performed.

Another aspect of the present disclosure provides a system comprising: a memory; and a processor, wherein the processor is configured to execute code stored on the memory for implementing a method of deriving a tensor based on a bitstream related to image data, the derived tensor being for processing using a portion of a neural network, the method comprising: decoding a tensor from the bitstream; and performing predetermined processing on the decoded tensor to generate the derived tensor, a number of dimensions of a data structure of the derived tensor being larger than a number of dimensions of a data structure of the decoded tensor; wherein the neural network includes at least a plurality of layers of a first type, a layer of the first type having at least a convolutional module and a batch-normalization module, and the derived tensor corresponds to a tensor in which a processing of the convolutional module of one of the plurality of layers of the first type has been performed but a processing of the batch-normalization module of the one of the plurality of layers of the first type has not been performed.

Other aspects are also disclosed.

### BRIEF DESCRIPTION OF THE DRAWINGS

At least one embodiment of the present invention will now be described with reference to the following drawings and an appendix, in which:

FIG. 1 is a schematic block diagram showing a distributed machine task system;

FIGS. 2A and 2B form a schematic block diagram of a general purpose computer system upon which the distributed machine task system of FIG. 1 may be practiced;

FIG. 3A is a schematic block diagram showing functional modules of a backbone portion of a CNN;

FIG. 3B is a schematic block diagram showing a residual block of FIG. 3A;

FIG. 3C is a schematic block diagram showing a residual unit of FIG. 3A;

FIG. 3D is a schematic block diagram showing a CBL module of FIG. 3A;

FIG. 4 is a schematic block diagram showing a backbone portion of CNNs for object tracking;

FIG. 5 is a schematic block diagram showing a portion of CNNs that contains multi-scale feature encoder part;

FIG. 6A shows a method for performing a first portion of a CNN, constricting using a bottleneck encoder, and encoding resulting constricted feature maps;

FIG. 6B shows a method for performing a first portion of a CNN, constricting using a bottleneck encoder, and encoding resulting constricted feature maps;

FIG. 7 is a schematic block diagram showing a packing arrangement for a plurality of compressed tensors;

FIG. 8 is a schematic block diagram showing functional modules of a video encoder;

FIG. 9 is a schematic block diagram showing functional modules of a video decoder;

FIG. 10 is a schematic block diagram showing a portion of CNNs that contains multi-scale feature decoder part;

FIG. 11 shows a method for decoding a bitstream, reconstructing decorrelated feature maps, and performing a second portion of the CNN;

FIG. 12 shows a method for decoding a bitstream, reconstructing decorrelated feature maps, and performing a second portion of the CNN;

FIG. 13 is a schematic block diagram showing a head portion of CNNs for object tracking;

FIG. 14A is a schematic block diagram showing an alternative multi-scale feature fusion module;

FIG. 14B is a schematic block diagram showing an alternative multi-scale feature reconstruction module;

FIG. 15A is a schematic block diagram showing an alternative bottleneck encoder; and

FIG. 15B is a schematic block diagram showing an alternative bottleneck decoder.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

A distributed machine task system may include an edge device, such as a network camera or smartphone producing intermediate compressed data. The distributed machine task system may also include a final device, such as a server-farm based (‘cloud’) application, operating on the intermediate compressed data to produce some task result. Additionally, the edge device functionality may be embodied in the cloud and the intermediate compressed data may be stored for later processing, potentially for multiple different tasks depending on need. An example of machine task is object tracking, with mean object tracking accuracy (MOTA) score as a typical task result. Other examples of machine task include object detection and instance segmentation, both of which produce a task result measured as ‘mean average precision’ (mAP) for detection over a threshold value of intersection-over-union (IoU), such as 0.5.

A convenient form of intermediate compressed data is a compressed video bitstream, owing to the availability of high-performing compression standards and implementations thereof. Video compression standards typically operate on integer samples of some given bit depth, such as 10 bits, arranged in planar arrays. Colour video has three planar arrays, corresponding, for example, to colour components Y, Cb, Cr, or R, G, B, depending on application. CNNs typically operate on floating point data in the form of tensors. Tensors generally have a much smaller spatial dimensionality compared to incoming video data upon which the CNN operates but have many more channels than the three channels typical of colour video data.

Tensors typically have the following dimensions: Frames, channels, height, and width. For example, a tensor of dimensions [1, 256, 76, 136] would be said to contain two-hundred and fifty-six (256) feature maps, each of size 136×76. For video data, inferencing is typically performed one frame at a time, rather than using tensors containing multiple frames.

VVC supports a division of a picture into multiple subpictures, each of which may be independently encoded and independently decoded. In one approach, each subpicture is coded as one ‘slice’, or contiguous sequence of coded CTUs. A ‘tile’ mechanism is also available to divide a picture into a number of independently decodeable regions. Subpictures may be specified in a somewhat flexible manner, with various rectangular sets of CTUs coded as respective subpictures. Flexible definition of subpicture dimensions allows efficiently holding types of data requiring different areas in one picture, avoiding large ‘unused’ areas, i.e., areas of a frame that are not used for reconstruction of tensor data.

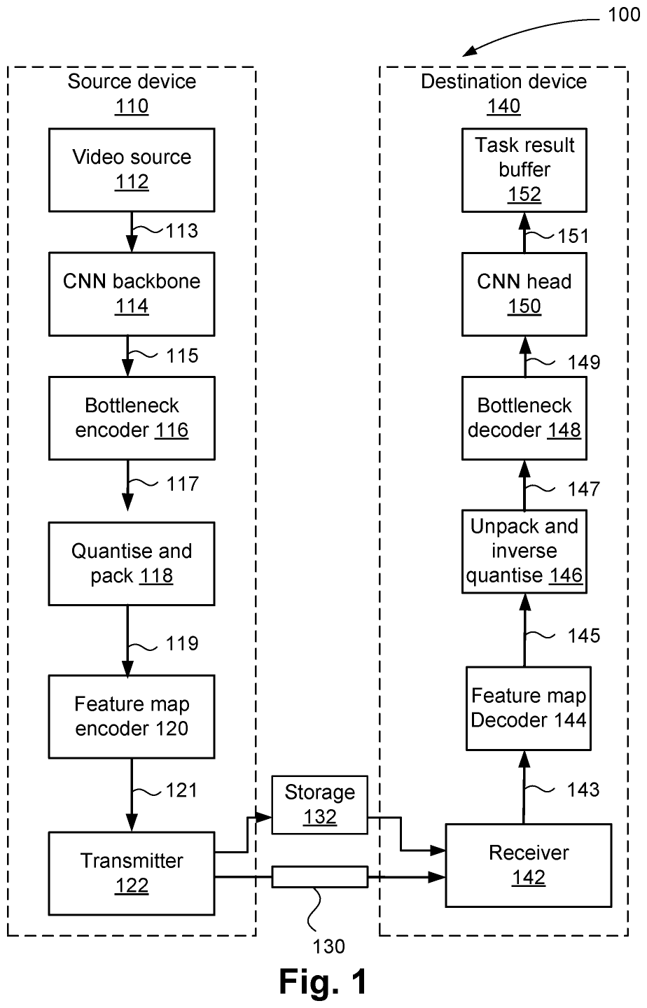

FIG. 1 is a schematic block diagram showing functional modules of a distributed machine task system 100. The notion of distributing a machine task across multiple systems is sometimes referred to as ‘collaborative intelligence’ (CI). The system 100 may be used for implementing methods for decorrelating, packing and quantising feature maps into planar frames for encoding and decoding feature maps from encoded data. The methods may be implemented such that associated overhead data is not too burdensome and task performance on the decoded feature maps is resilient to changing bitrate of the bitstream and the quantised representation of the tensors does not needlessly consume bits where the bits do not provide a commensurate benefit in terms of task performance.

The system 100 includes a source device 110 for generating encoded tensor data 115 from a CNN backbone 114 in the form of an encoded video bitstream 121. The system 100 also includes a destination device 140 for decoding tensor data in the form of an encoded video bitstream 143. A communication channel 130 is used to communicate the encoded video bitstream 121 from the source device 110 to the destination device 140. In some arrangements, the source device 110 and destination device 140 may either or both comprise respective mobile telephone handsets (e.g., “smartphones”) or network cameras and cloud applications. The communication channel 130 may be a wired connection, such as Ethernet, or a wireless connection, such as WiFi or 5G, including connections across a Wide Area Network (WAN) or across ad-hoc connections. Moreover, the source device 110 and the destination device 140 may comprise applications where encoded video data is captured on some computer-readable storage medium, such as a hard disk drive in a file server or memory.

As shown in FIG. 1, the source device 110 includes a video source 112, the CNN backbone 114, a bottleneck encoder 116, a quantise and pack module 118, a feature map encoder 120, and a transmitter 122. The video source 112 typically comprises a source of captured video frame data (shown as 113), such as an image capture sensor, a previously captured video sequence stored on a non-transitory recording medium, or a video feed from a remote image capture sensor. The video source 112 may also be an output of a computer graphics card, for example, displaying the video output of an operating system and various applications executing upon a computing device (e.g., a tablet computer). Examples of source devices 110 that may include an image capture sensor as the video source 112 include smart-phones, video camcorders, professional video cameras, and network video cameras.

The system 100 reduces dimensionality of tensors at the interface between the first network portion and the second network portion using a ‘bottleneck’, i.e., additional network layers that restrict tensor dimensionality on the encoding side and restore tensor dimensionality at the decoder side. The multi-scale representation produced by a feature pyramid network (FPN) is ‘fused’ together into a single tensor using an approach named ‘multi-scale feature compression’ (MSFC). MSFC is ordinarily used to merge all FPN layers into a single tensor. Merging all FPN layers into a single tensor is implemented at the expense of spatial detail for the less decomposed (larger) layers of the FPN. The loss of spatial detail can result in an unacceptable decrease in accuracy for some tasks or operations implemented by the system 100.

The arrangements described separate tensors of the FPN into groups and separately apply MSFC techniques rather than merging all FPN layers into a single tensor. Separately applying MFSC techniques permits a degree of cross-layer fusion without such severe degradation of spatial detail. For tasks requiring preservation of greater spatial detail, such as instance segmentation, the resulting mAP is higher using separate MSFC techniques than if all FPN layers are merged into a single tensor with low spatial resolution.

The CNN backbone 114 receives the video frame data 113 and performs specific layers of an overall CNN, such as layers corresponding to the ‘backbone’ of the CNN, outputting tensors 115. The backbone layers of the CNN may produce multiple tensors as output, for example, corresponding to different spatial scales of an input image represented by the video frame data 113, sometimes referred to as a ‘feature pyramid network’ (FPN) architecture. The tensors resulting from an FPN backbone form a hierarchical representation of the frame data 113 including data of feature maps. Each successive layer of the hierarchical representation has half the width and height of the preceding layer. Later layers that are produced further into in the backbone network tend to contain features having a more abstract representation of the frame data 113. Less decomposed layers, produced earlier in the backbone network, tend to contain features representing less abstract features of the frame data 113, such as various geometric properties such as edges of various angles. An FPN may result in three tensors, corresponding to three layers, output from the backbone 114 as the tensors 115 when a ‘YOLOv3’ network is performed by the system 100, with varying spatial resolution and channel count. When the system 100 is performing networks such as ‘Faster RCNN X101-FPN” or “Mask RCNN X101-FPN” the tensors 115 include tensors for four layers P2-P5. The bottleneck encoder 116 receives tensors 115. The bottleneck encoder 116 acts to compress one or more internal layers of the overall CNN. The internal layers of the overall CNN provide the output of the CNN backbone 114, compressed or constricted by the bottleneck encoder 116 using a set of neural network layers trained to convert to a lower channel count and smaller spatial resolution than required by the tensors 115. The bottleneck encoder 116 outputs a bottleneck tensor 117.

The bottleneck tensor 117 is passed to the quantise and pack module 118. Each feature map of the bottleneck tensor 117 is quantised from floating point to integer precision and packed into a monochrome frame by the module 118 to produce a packed frame 119. The packed frame 119 is input to the feature map encoder 120. The feature map encoder 120 encodes the pack frame 118 to generate a bitstream 121. The bitstream 121 is supplied to the transmitter 122 for transmission over the communications channel 130 or the bitstream 121 is written to storage 132 for later use.

The source device 110 supports a particular network for the CNN backbone 114. However, the destination device 140 may use one of several networks for the head CNN 150. In this way, partially processed data in the form of packed feature maps may be stored for later use in performing various tasks without needing to repeatedly perform the operation of the CNN backbone 114.

The bitstream 121 is transmitted by the transmitter 122 over the communication channel 130 as encoded video data (or “encoded video information”). The bitstream 121 can in some implementations be stored in the storage 132, where the storage 132 is a non-transitory storage device such as a “Flash” memory or a hard disk drive, until later being transmitted over the communication channel 130 (or in-lieu of transmission over the communication channel 130). For example, encoded video data may be served upon demand to customers over a wide area network (WAN) for a video analytics application.

The destination device 140 includes a receiver 142, a feature map decoder 144, an unpack and inverse quantise module 146, a bottle neck decoder 148, a CNN head 150, and a CNN task result buffer 152. The receiver 142 receives encoded video data from the communication channel 130 and passes the video bitstream 143 to the feature map decoder 144. The feature map decoder decodes the bitstream to generate a decoded packed frame 145. The decoded frame is input to the unpack and inverse quantise module 146. The module 146 unpacks and inverse quantises the tensors of the frame 145 to generate dequantized tensors, output as decoded bottleneck tensors 147. The decoded bottleneck tensors 147 are supplied to the bottleneck decoder 148. The bottleneck decoder 148 performs the inverse operation of the bottleneck encoder 116, to produce extracted tensors 149. The extracted tensors 149 are passed to the CNN head 150. The CNN head 150 performs the later layers of the task that began with the CNN backbone 114 to produce a task result 151, which is stored in a task result buffer 152. The contents of the task result buffer 152 may be presented to the user, e.g., via a graphical user interface, or provided to an analytics application where some action is decided based on the task result, which may include summary level presentation of aggregated task results to a user. It is also possible for the functionality of each of the source device 110 and the destination device 140 to be embodied in a single device, examples of which include mobile telephone handsets and tablet computers and cloud applications.

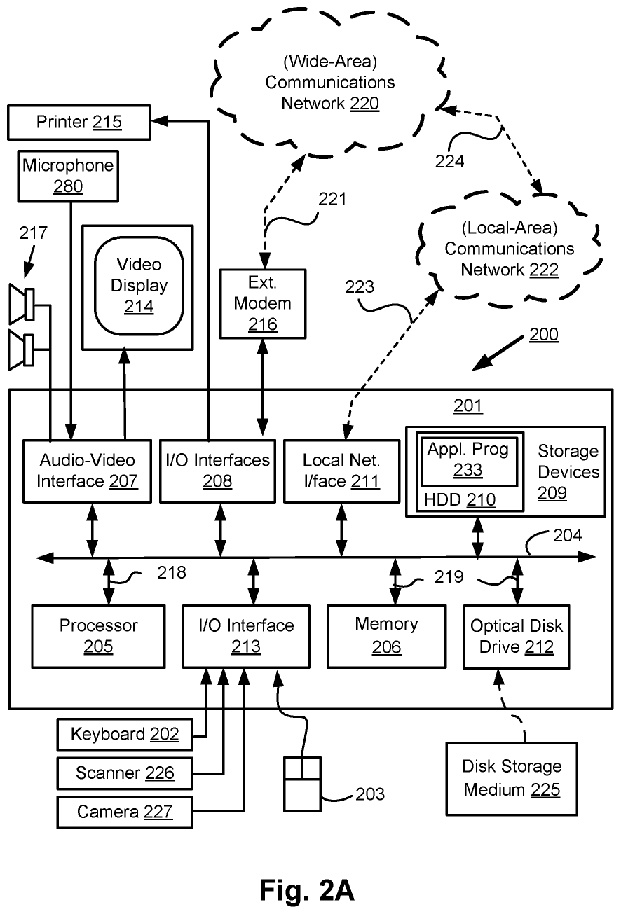

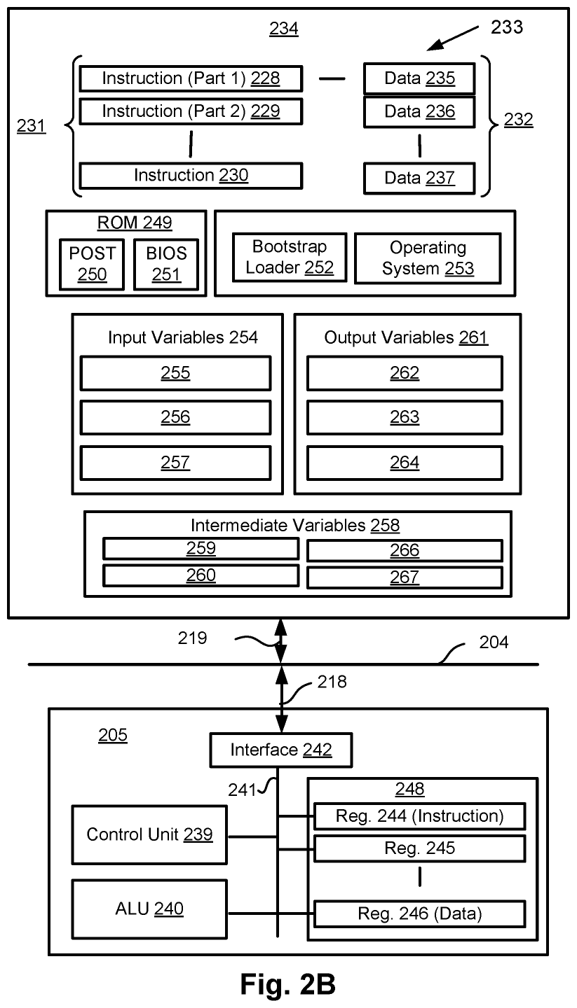

Notwithstanding the example devices mentioned above, each of the source device 110 and destination device 140 may be configured within a general-purpose computing system, typically through a combination of hardware and software components. FIG. 2A illustrates such a computer system 200, which includes: a computer module 201; input devices such as a keyboard 202, a mouse pointer device 203, a scanner 226, a camera 227, which may be configured as the video source 112, and a microphone 280; and output devices including a printer 215, a display device 214, which may be configured as a display device presenting the task result 151, and loudspeakers 217. An external Modulator-Demodulator (Modem) transceiver device 216 may be used by the computer module 201 for communicating to and from a communications network 220 via a connection 221. The communications network 220, which may represent the communication channel 130, may be a (WAN), such as the Internet, a cellular telecommunications network, or a private WAN. Where the connection 221 is a telephone line, the modem 216 may be a traditional “dial-up” modem. Alternatively, where the connection 221 is a high capacity (e.g., cable or optical) connection, the modem 216 may be a broadband modem. A wireless modem may also be used for wireless connection to the communications network 220. The transceiver device 216 may provide the functionality of the transmitter 122 and the receiver 142 and the communication channel 130 may be embodied in the connection 221.

The computer module 201 typically includes at least one processor unit 205, and a memory unit 206. For example, the memory unit 206 may have semiconductor random access memory (RAM) and semiconductor read only memory (ROM). The computer module 201 also includes a number of input/output (I/O) interfaces including: an audio-video interface 207 that couples to the video display 214, loudspeakers 217 and microphone 280; an I/O interface 213 that couples to the keyboard 202, mouse 203, scanner 226, camera 227 and optionally a joystick or other human interface device (not illustrated); and an interface 208 for the external modem 216 and printer 215. The signal from the audio-video interface 207 to the computer monitor 214 is generally the output of a computer graphics card. In some implementations, the modem 216 may be incorporated within the computer module 201, for example within the interface 208. The computer module 201 also has a local network interface 211, which permits coupling of the computer system 200 via a connection 223 to a local-area communications network 222, known as a Local Area Network (LAN). As illustrated in FIG. 2A, the local communications network 222 may also couple to the wide network 220 via a connection 224, which would typically include a so-called “firewall”device or device of similar functionality. The local network interface 211 may comprise an Ethernet™ circuit card, a Bluetooth™ wireless arrangement or an IEEE 802.11 wireless arrangement; however, numerous other types of interfaces may be practiced for the interface 211. The local network interface 211 may also provide the functionality of the transmitter 122 and the receiver 142 and communication channel 130 may also be embodied in the local communications network 222.

The I/O interfaces 208 and 213 may afford either or both of serial and parallel connectivity, the former typically being implemented according to the Universal Serial Bus (USB) standards and having corresponding USB connectors (not illustrated). Storage devices 209 are provided and typically include a hard disk drive (HDD) 210. Other storage devices such as a floppy disk drive and a magnetic tape drive (not illustrated) may also be used. An optical disk drive 212 is typically provided to act as a non-volatile source of data. Portable memory devices, such optical disks (e.g., CD-ROM, DVD, Blu ray Disc™), USB-RAM, portable, external hard drives, and floppy disks, for example, may be used as appropriate sources of data to the computer system 200. Typically, any of the HDD 210, optical drive 212, networks 220 and 222 may also be configured to operate as the video source 112, or as a destination for decoded video data to be stored for reproduction via the display 214. The source device 110 and the destination device 140 of the system 100 may be embodied in the computer system 200.

The components 205 to 213 of the computer module 201 typically communicate via an interconnected bus 204 and in a manner that results in a conventional mode of operation of the computer system 200 known to those in the relevant art. For example, the processor 205 is coupled to the system bus 204 using a connection 218. Likewise, the memory 206 and optical disk drive 212 are coupled to the system bus 204 by connections 219. Examples of computers on which the described arrangements can be practised include IBM-PC's and compatibles, Sun SPARCstations, Apple Mac™ or alike computer systems.

Where appropriate or desired, the source device 110 and the destination device 140, as well as methods described below, may be implemented using the computer system 200. In particular, the source device 110, the destination device 140 and methods to be described, may be implemented as one or more software application programs 233 executable within the computer system 200. The source device 110, the destination device 140 and the steps of the described methods are effected by instructions 231 (see FIG. 2B) in the software 233 that are carried out within the computer system 200. The software instructions 231 may be formed as one or more code modules, each for performing one or more particular tasks. The software may also be divided into two separate parts, in which a first part and the corresponding code modules performs the described methods and a second part and the corresponding code modules manage a user interface between the first part and the user.

The software may be stored in a computer readable medium, including the storage devices described below, for example. The software is loaded into the computer system 200 from the computer readable medium, and then executed by the computer system 200. A computer readable medium having such software or computer program recorded on the computer readable medium is a computer program product. The use of the computer program product in the computer system 200 preferably effects an advantageous apparatus for implementing the source device 110 and the destination device 140 and the described methods.

The software 233 is typically stored in the HDD 210 or the memory 206. The software is loaded into the computer system 200 from a computer readable medium and executed by the computer system 200. Thus, for example, the software 233 may be stored on an optically readable disk storage medium (e.g., CD-ROM) 225 that is read by the optical disk drive 212.

In some instances, the application programs 233 may be supplied to the user encoded on one or more CD-ROMs 225 and read via the corresponding drive 212, or alternatively may be read by the user from the networks 220 or 222. Still further, the software can also be loaded into the computer system 200 from other computer readable media. Computer readable storage media refers to any non-transitory tangible storage medium that provides recorded instructions and/or data to the computer system 200 for execution and/or processing. Examples of such storage media include floppy disks, magnetic tape, CD-ROM, DVD, Blu-ray Disc™, a hard disk drive, a ROM or integrated circuit, USB memory, a magneto-optical disk, or a computer readable card such as a PCMCIA card and the like, whether or not such devices are internal or external of the computer module 201. Examples of transitory or non-tangible computer readable transmission media that may also participate in the provision of the software, application programs, instructions and/or video data or encoded video data to the computer module 201 include radio or infra-red transmission channels, as well as a network connection to another computer or networked device, and the Internet or Intranets including e-mail transmissions and information recorded on Websites and the like.

The second part of the application program 233 and the corresponding code modules mentioned above may be executed to implement one or more graphical user interfaces (GUIs) to be rendered or otherwise represented upon the display 214. Through manipulation of typically the keyboard 202 and the mouse 203, a user of the computer system 200 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 217 and user voice commands input via the microphone 280.

FIG. 2B is a detailed schematic block diagram of the processor 205 and a “memory” 234. The memory 234 represents a logical aggregation of all the memory modules (including the storage devices 209 and semiconductor memory 206) that can be accessed by the computer module 201 in FIG. 2A.

When the computer module 201 is initially powered up, a power-on self-test (POST) program 250 executes. The POST program 250 is typically stored in a ROM 249 of the semiconductor memory 206 of FIG. 2A. A hardware device such as the ROM 249 storing software is sometimes referred to as firmware. The POST program 250 examines hardware within the computer module 201 to ensure proper functioning and typically checks the processor 205, the memory 234 (209, 206), and a basic input-output systems software (BIOS) module 251, also typically stored in the ROM 249, for correct operation. Once the POST program 250 has run successfully, the BIOS 251 activates the hard disk drive 210 of FIG. 2A. Activation of the hard disk drive 210 causes a bootstrap loader program 252 that is resident on the hard disk drive 210 to execute via the processor 205. This loads an operating system 253 into the RAM memory 206, upon which the operating system 253 commences operation. The operating system 253 is a system level application, executable by the processor 205, to fulfil various high-level functions, including processor management, memory management, device management, storage management, software application interface, and generic user interface.

The operating system 253 manages the memory 234 (209, 206) to ensure that each process or application running on the computer module 201 has sufficient memory in which to execute without colliding with memory allocated to another process. Furthermore, the different types of memory available in the computer system 200 of FIG. 2A need to be used properly so that each process can run effectively. Accordingly, the aggregated memory 234 is not intended to illustrate how particular segments of memory are allocated (unless otherwise stated), but rather to provide a general view of the memory accessible by the computer system 200 and how such memory is used.

As shown in FIG. 2B, the processor 205 includes a number of functional modules including a control unit 239, an arithmetic logic unit (ALU) 240, and a local or internal memory 248, sometimes called a cache memory. The cache memory 248 typically includes a number of storage registers 244-246 in a register section. One or more internal busses 241 functionally interconnect these functional modules. The processor 205 typically also has one or more interfaces 242 for communicating with external devices via the system bus 204, using a connection 218. The memory 234 is coupled to the bus 204 using a connection 219.

The application program 233 includes a sequence of instructions 231 that may include conditional branch and loop instructions. The program 233 may also include data 232 which is used in execution of the program 233. The instructions 231 and the data 232 are stored in memory locations 228, 229, 230 and 235, 236, 237, respectively. Depending upon the relative size of the instructions 231 and the memory locations 228-230, a particular instruction may be stored in a single memory location as depicted by the instruction shown in the memory location 230. Alternately, an instruction may be segmented into a number of parts each of which is stored in a separate memory location, as depicted by the instruction segments shown in the memory locations 228 and 229.

In general, the processor 205 is given a set of instructions which are executed therein. The processor 205 waits for a subsequent input, to which the processor 205 reacts to by executing another set of instructions. Each input may be provided from one or more of a number of sources, including data generated by one or more of the input devices 202, 203, data received from an external source across one of the networks 220, 202, data retrieved from one of the storage devices 206, 209 or data retrieved from a storage medium 225 inserted into the corresponding reader 212, all depicted in FIG. 2A. The execution of a set of the instructions may in some cases result in output of data. Execution may also involve storing data or variables to the memory 234.

The bottleneck encoder 116, the bottleneck decoder 148 and the described methods may use input variables 254, which are stored in the memory 234 in corresponding memory locations 255, 256, 257. The bottleneck encoder 116, the bottleneck decoder 148 and the described methods produce output variables 261, which are stored in the memory 234 in corresponding memory locations 262, 263, 264. Intermediate variables 258 may be stored in memory locations 259, 260, 266 and 267.

Referring to the processor 205 of FIG. 2B, the registers 244, 245, 246, the arithmetic logic unit (ALU) 240, and the control unit 239 work together to perform sequences of micro-operations needed to perform “fetch, decode, and execute” cycles for every instruction in the instruction set making up the program 233. Each fetch, decode, and execute cycle comprises:
a fetch operation, which fetches or reads an instruction 231 from a memory location 228, 229, 230;
a decode operation in which the control unit 239 determines which instruction has been fetched; and
an execute operation in which the control unit 239 and/or the ALU 240 execute the instruction.

Thereafter, a further fetch, decode, and execute cycle for the next instruction may be executed. Similarly, a store cycle may be performed by which the control unit 239 stores or writes a value to a memory location 232.

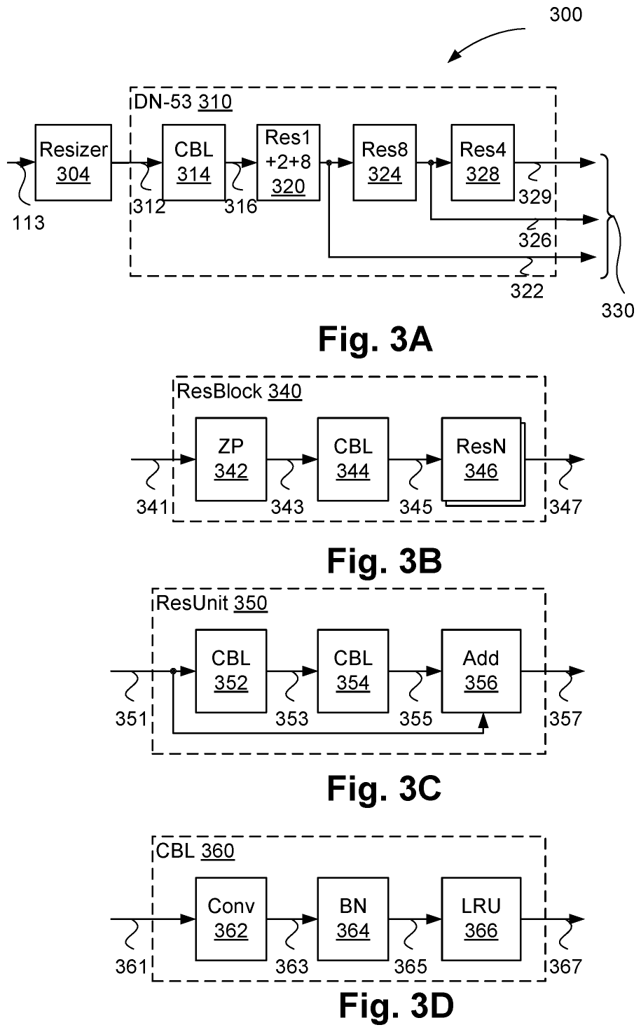

Each step or sub-process in the methods of FIGS. 3-6 and 8-13, to be described, is associated with one or more segments of the program 233 and is typically performed by the register section 244, 245, 247, the ALU 240, and the control unit 239 in the processor 205 working together to perform the fetch, decode, and execute cycles for every instruction in the instruction set for the noted segments of the program 233.

FIG. 3A is a schematic block diagram showing an architecture 300 of functional modules of a feature extraction portion 310 of a CNN. The feature extraction portion 310 forms a portion of an implementation of the CNN 114 backbone and can be followed by a “skip connection” in a network such as YOLOv3. The CNN portion 310 can be referred to as “Dark-Net 53”. Different feature extractions are also possible, resulting in a different number of and dimensionality of layers of the tensors 330 output for each frame.

As shown in FIG. 3A, the video data 113 is passed to a resizer module 304. The resizer module 314 resizes the frame to a resolution suitable for processing by the CNN portion 310, producing resized frame data 312. If the resolution of the frame data 113 is already suitable for the CNN backbone 310 then operation of the resizer module 304 is not needed. The resized frame data 312 is passed to a convolutional batch normalisation leaky rectified linear (CBL) module 314 (also referred to as a CBL layer) to produce tensors 316. The CBL 314 contains modules as described with reference to a CBL module 360, as shown in FIG. 3D.

Referring to FIG. 3D, the CBL module 360 takes as input a tensor 361. The tensor 361 is passed to a convolutional layer 362 to produce tensor 363. When the convolutional layer 362 has a stride of one and padding is set to k samples, with a convolutional kernel of size 2k+1, the tensor 363 has the same spatial dimensions as the tensor 361. When the convolution layer 362 has a larger stride, such as two, the tensor 363 has smaller spatial dimensions compared to the tensor 361, for example, halved in size for the stride of two. Regardless of the stride, the size of channel dimension of the tensor 363 may vary compared to the channel dimension of the tensor 361 for a particular CBL block. The tensor 363 is passed to a batch normalisation module 364 which outputs a tensor 365. The batch normalisation module 364 normalises the input tensor 363, applies a scaling factor and offset value to produce the output tensor 365. The scaling factor and offset value are derived from a training process. The tensor 365 is passed to a leaky rectified linear activation (“Leaky ReLU”) module 366 to produce a tensor 367. The module 366 provides a ‘leaky’ activation function whereby positive values in the tensor are passed through and negative values are severely reduced in magnitude, for example, to 0.1× their former value.

Returning to FIG. 3A, the tensor 316 is passed from the CBL block 314 to a residual block 11 module 320. The module 320 contains a sequential concatenation of three residual blocks, containing 1, 2, and 8 residual units internally, respectively.

A residual block, such as present in the module 320, is described with reference to a ResBlock 340 as shown in FIG. 3B. The ResBlock 340 receives a tensor 341. The tensor 341 is zero-padded by a zero-padding module 342 to produce a tensor 343. The tensor 343 is passed to a CBL module 344 to produce a tensor 345. The tensor 345 is passed to a residual unit 346, of which the residual block 340 includes a series of concatenated residual units. The last residual unit of the residual units 346 outputs a tensor 347.

A residual unit, such as the unit 346, is described with reference to a ResUnit 350 as shown in FIG. 3C. The ResUnit 350 takes a tensor 351 as input. The tensor 351 is passed to a CBL module 352 to produce a tensor 353. The tensor 353 is passed to a second CBL unit 354 to produce a tensor 355. An add module 356 sums the tensor 355 with the tensor 351 to produce a tensor 357. The add module 356 may also be referred to as a ‘shortcut’ as the input tensor 351 substantially influences the output tensor 357. For an untrained network, ResUnit 350 acts to pass-through tensors. As training is performed, the CBL modules 352 and 354 act to deviate the tensor 357 away from the tensor 351 in accordance with training data and ground truth data.

Returning to FIG. 3A, the Res11 module 320 outputs a tensor 322. The tensor 322 is output from the backbone module 310 as one of the layers and also provided to a Res8 module 324. The Res8 module 324 is a residual block (i.e., 340), which includes eight residual units (i.e. 350). The Res8 module 324 produces a tensor 326. The tensor 326 is passed to a Res4 module 328 and output from the backbone module 310 as one of the layers. The Res4 module is a residual block (i.e., 340), which includes four residual units (i.e., 350). The Res4 module 324 produces a tensor 329. The tensor 329 is output from the backbone module 310 as one of the layers. Collectively, the layer tensors 322, 326, and 329 are output as tensors 115.

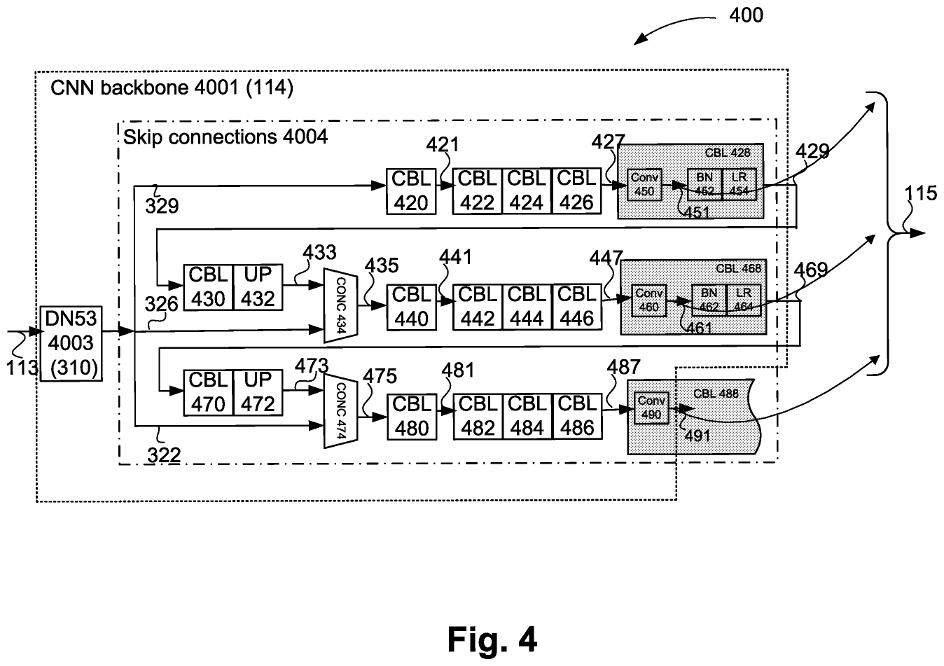

FIG. 4 is a schematic block diagram showing an architecture 400 of functional modules of a CNN backbone network 4001 that may serve as an implementation of the CNN backbone 114. The backbone portion 4001 implements a connection of feature extraction network Darknet-53 310 and a portion of skip connections 4004. Frame data 113 is input to the Darknet-53 network 310 to produce the three tensors 329, 326, and 322. The three tensors 329, 326, and 322 may have different numbers of channels and/or different spatial resolution or scale. The tensors 329, 326, and 322 are passed to the skip connections 4004 which produces tensors 451, 461, 491, 429 and 469. The tensors 429 and 469, in addition to being outputs from the skip connections 4004, from the skip connections are used within the skip connections 4004 to provide support for other layers within the skip connection 4004, as described below. The tensors 451, 461, and 491 may serve as the tensors 115.

The skip connections 400 contain three sequences (or ‘tracks’) of CBL layers. The CBL layers within each sequence of CBL layers in the architecture 400 block may be implemented using the structure of the CBL 360 and contains a sequentially chained convolutional layer module, a Batch normalization layer module, and a Leaky ReLU layer module. The first track takes the first tensor 329 from Darknet-53 network 310. The tensor 329 is passed through five CBL layers 420, 422, 424, 426, and 428. The first CBL 420 outputs a tensor 421. The tensor 421 is passed serially through the sequence of CBLs 422, 424, 426 and 428. The CBL 428 produces the first tensor 451 of the tensors 115 and the tensor 429 of the skip connections portion 4004. The second track takes the output tensor 429 of the first track, performs a CBL layer 430 followed by an upsampling block 423 to produce a tensor 433. The tensor 433 is concatenated with the second tensor 326 via a concatenation block 434 to produce a tensor 435. The tensor 435 passes through five blocks of CBL 440, 442, 444, 446, and 468. The first CBL 440 outputs a tensor 441. The tensor 441 is passed serially through the sequence of CBLs 442, 444, 446 and 468. The CBL 468 produces the second tensor 461 of the tensor 115 and the tensor 469 of the skip connections portion 4004. The third track takes the output tensor 469 of the second track, and performs a CBL block 470 followed by an upsampling block 472 to produce a tensor 473. The tensor 473 is concatenated with the third feature map 322 via a concatenation block 474 to produce tensor 475. The tensor 475 passes through four blocks of CBL 480, 482, 484, and 486. The first CBL 480 outputs a tensor 481. The tensor 481 is passed serially through the sequence of CBLs 482, 484 and 486 to produce a tensor 487. The tensor 487 is input to a convolutional layer 490 of a CBL 488 to produce the third tensor 491 of the tensors 115.

The split point between the backbone CNN 114 and the head CNN 150 in previous arrangements could be selected at (i) the output of the Darknet-53 CNN 310 (tensors 329, 326, and 322), (ii) after the first CBL block of the five CBL blocks in each track (tensors 421, 441, and 481), or (iii) after the final CBL block of the five CBL blocks (tensors 429 and 469, and a tensor output of the CBL 488). In the arrangements described, the split point of the CNN backbone 114 can also be taken at the output of each convolutional module in each of the CBL layers 428, 448, and 488 (outputting the tensors 451, 461 and 491).

In the example CNN backbone 4001 the split points are selected at the output of each convolutional module in the last CBL layers 428, 448, and 488 of each track of CBL layers within the skip connections 4004. The tensors output from the split points are 451, 461, and 491. The three tensors 451, 461, and 491 provide the tensors 115. In the example described, the split point is after convolutional modules inside CBL layers. The CBL layers 428, 468, and 488 can be considered the last layers of the three tracks of the portion of the neural network which includes a convolutional layer. The split point is effectively in the three last layers of each track of the skip connections portion 4004.

The CBL layer 428 contains three modules: a convolutional module 450, a batch normalization module 452, and a Leaky ReLU module 454. A tensor 427, generated by the CBL 426, is input to the convolutional layer 450 to produce the tensor 451. The tensor 451 provides the first tensor of the tensors 115. The CBL layer 468 contains three modules: a convolutional module 460, a batch normalization module 462, and a Leaky ReLU module 464. A tensor 447, output by the CBL 446, is input to the convolutional layer 460 to produce the tensor 461. The tensor 461 provides the second tensor of the tensors 115. The layer 488 contains three modules, the convolutional module 490, a batch normalization module (not shown) and a Leaky ReLU module (not shown). Only the module 490 of the CBL 488 is performed in the backbone CNN 114.

The first tensor 451 from the split point needs to be passed through the batch normalization 452 and the Leaky ReLU 454 to produce the tensor 429. The tensor 429 goes back to the skip connections, for input to the CBL 430, so the backbone 114 needs include the modules 452 and 454. The second tensor 461 from the split point needs to be passed through the batch normalization 462 and the Leaky ReLU 464 to produce the tensor 469. The tensor 469 goes back to the skip connections for input to the CBL 470. Accordingly, the backbone CNN 114 needs to include the modules 462 and 464.

The backbone CNN 4001 may take as input a video frame of resolution 1088×608 and produce three tensors, corresponding to three layers, with the following dimensions: [1, 256, 76, 136], [1, 512, 38, 68], [1, 1024, 19, 34]. Another example of the three tensors corresponding to three layers may be [1, 512, 34, 19], [1, 256, 68, 38], [1, 128, 136, 76] which are respectively separated at 75th network layer, 90th network layer, and 105th network layer in the backbone CNN 4001 (corresponding to the output of CBL layers 420, 440, and 480, respectively, that is, the tensors 421, 441, and 481, respectively). Each tensor can have a different resolution to the next tensor. The resolution of the tensors can form an exponential sequence, with a doubling of height and width between each successive tensor among the tensors. In forming the output tenors 115, the modules 322, 326, and 329 provide a hierarchical representation of the frame data including data of feature maps for encoding to the bitstream. The separating points depend on the CNN 310.

The output tensor 429 of the first track and the output tensor 469 of the second track of the skip connections stage are continuously used for the second track and the third track of the skip connections 4004 in the source device 110. Accordingly, there are some “overlap” layers (or modules) which are both run in the backbone portion (114) in the source device 110 and the CNN head (150) in the destination device 140. In the third track (starting at CBL 470), there is no overlap layer, because the output tensor 491 of the third track is used only for the head 150 and is not fed back to another track in the skip connection 4004.

The overlap layers are layers or modules (i) after the first point of the split point (after the output of the module 450) to the end of the first track of the skip connections (module 452 and 454), and (ii) after the second point of the split point (after the output of the module 460) to the end of the second track of the skip connections (modules 462 and 464). If the split point is close to the end of the skip connections portion 4004, the number of overlap layers or modules is decreased. If the split point is taken after each of CBL layers 420, 440, and 480, the overlap layers are CBL 422, 424, 426, and 428 in the first track, and CBL 442, 444, 446, and 468 in the second track. As a result, selecting the split point to output the tensors 451, 461, and 491 reduces execution redundancy and reduces executing time of the end-to-end network of CNNs 114 and 150.

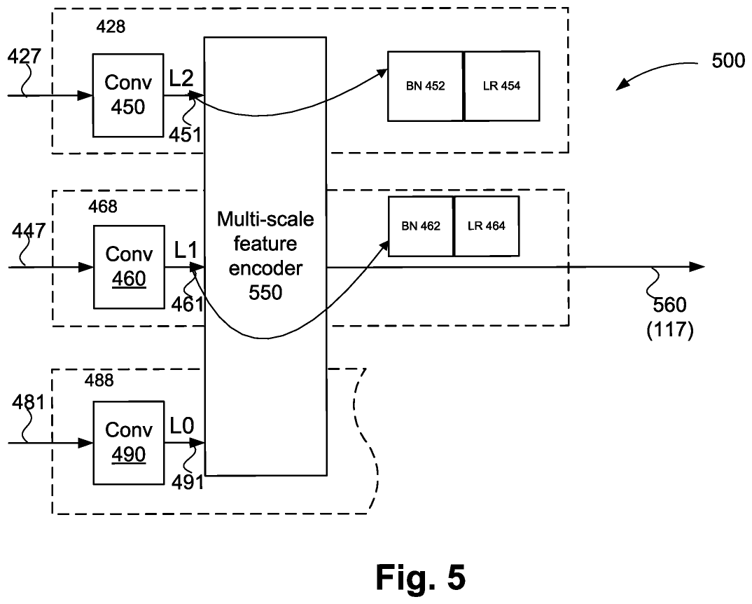

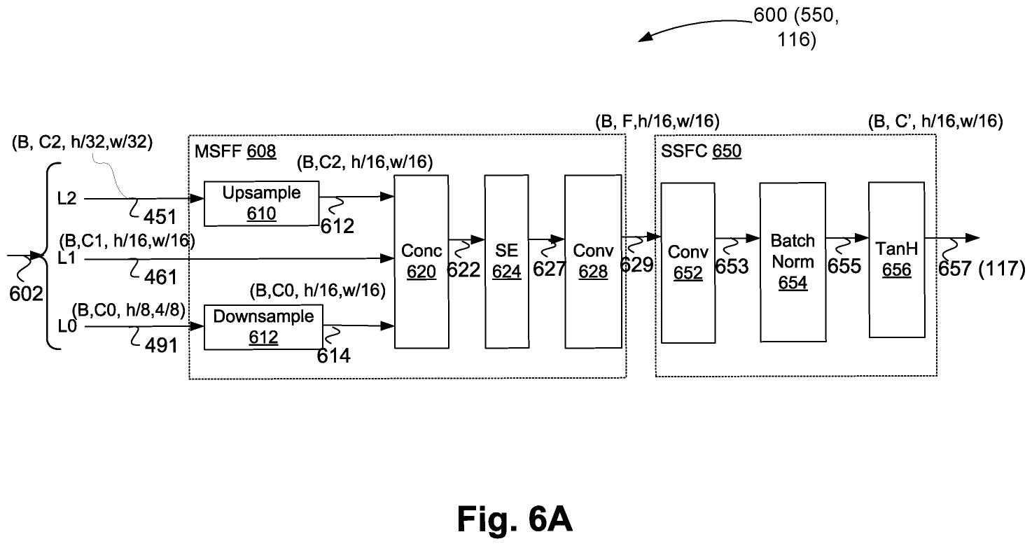

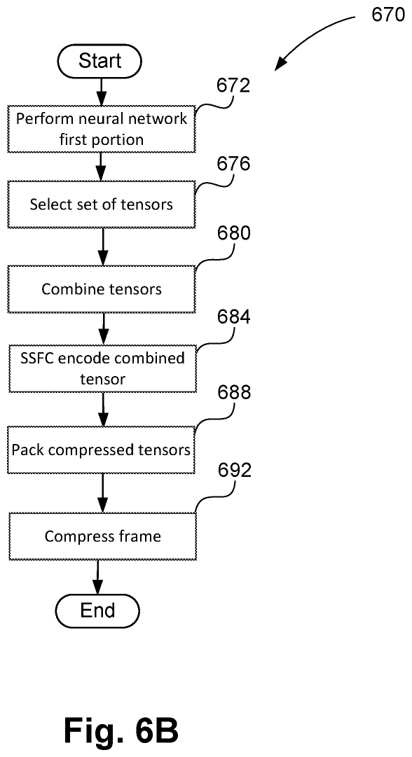

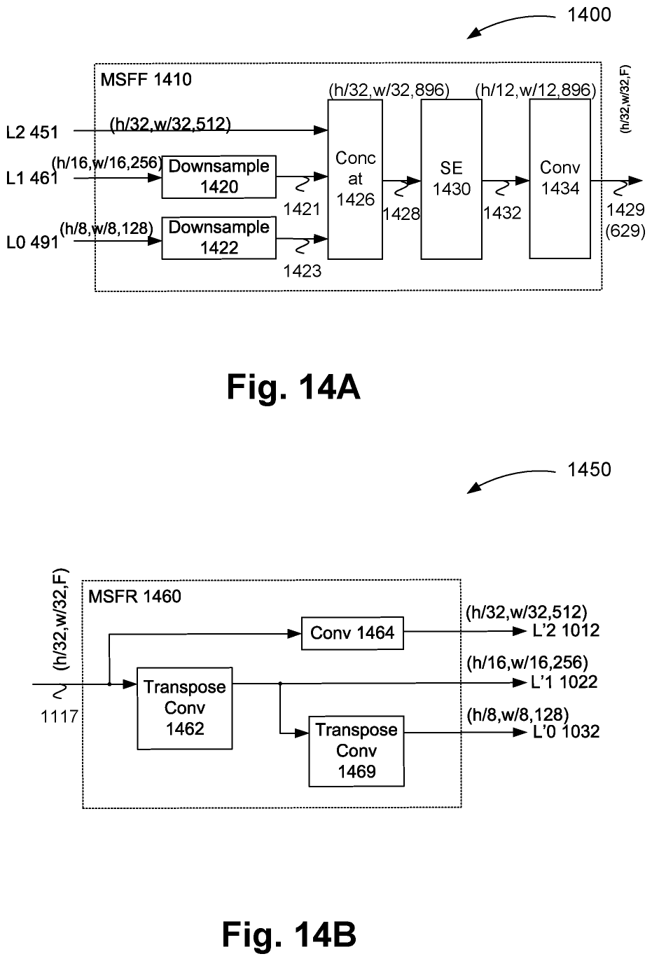

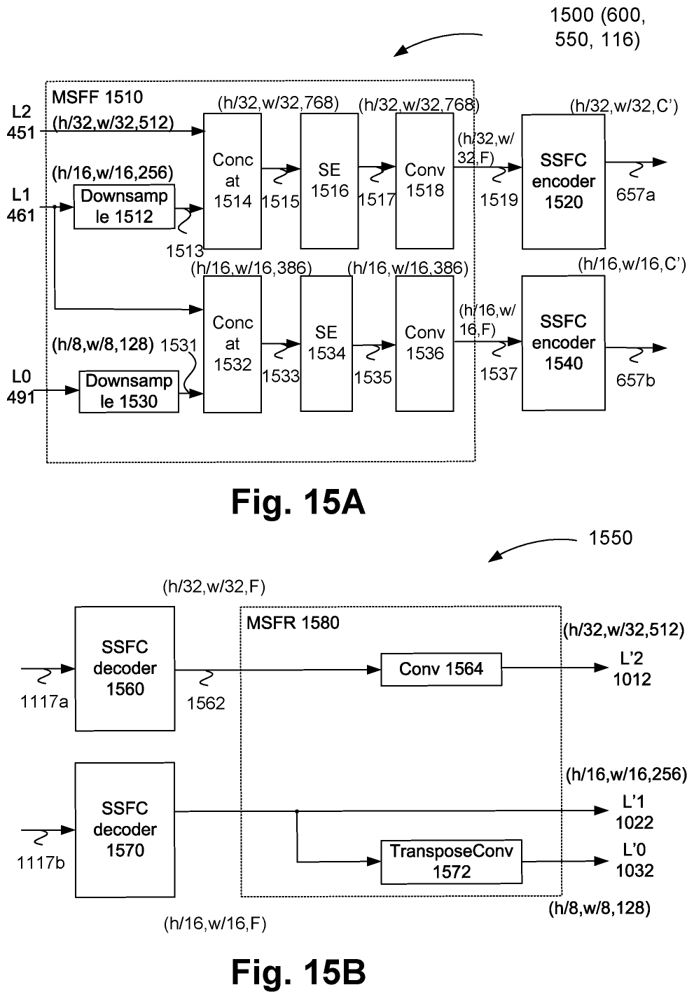

FIG. 5 is a schematic block diagram showing an architecture 500 of functional modules for performing encoding tensors generated by the three CBL layers 428, 448, and 488 in an example where the split point is selected at the output of the convolutional layers 450, 460 and 490. The tensors 427, 447, and 481 are input to the modules 428, 468 and 488 respectively. The tensors 427, 447, and 481 are input to the convolutional modules 450, 460, and 490 to produce three tensors L2 451, L1 461, and L0 491 respectively. As the split point takes tensors after each convolutional module in each CBL block 428, 448, 488, the tensors for which multi-scale feature encoding is implemented are [L2, L1, L0]. A multi-scale feature encoder 550 (corresponding to the bottleneck encoder 116) receives the tensors [L2, L1, L0] as input and produces output tensor(s) 560. The block 550 corresponds to the bottleneck encoder 116, and the output 560 corresponds to the output bottleneck tensor 117. The output 560 is one tensor in arrangements of the bottleneck encoder 550 that accord with FIG. 6A and FIG. 14A and is two tensors in an arrangement of the bottleneck encoder 550 that accords with FIG. 15A. Outputs of the modules 454 and 464 are not encoded by the encoder 550.

The multi-scale feature encoder 550 can use a convolutional neural network that can learn, train, create, and select features from input tensors of an FPN, such as L0, L1, and L2 to produce a representation having reduced dimensionality in terms of number of tensors, channel count and width and height within the compressed tensor(s). For example, MFSC can be used. The functional module 550 also can use an untrainable method such as PCA (Principal Component Analysis). A PCA implementation uses an orthogonal transformation to transform the number of a feature channels, such as 256, to a smaller number, such as 25, by taking 25 strongest features (eigen vectors or basis vectors) from the transformed features and using coefficients to represent contents of the 256 feature maps as a weighted sum of the basis vectors. To take advantage of inter-feature maps transformation in PCA, the smaller spatial resolution tensor, such as L2, can be upsampled before concatenating with a larger spatial resolution tensor, such as L1 The eigen vectors are transformed from the concatenated tensor. If the PCA method is used, the coefficients also need to be encoded and transferred to the head portion 150 for the purpose of decoding.

Using the split point described, the CNN head 114 outputs tensors 451, 461, and 491, each produced by a convolutional module. Typically, tensors produced from convolutional modules are more stable when training with a multi-scale feature compression. Using other split points described can result in the tensors 115 (such as (329, 326, 322) or (421, 441, 481)) being produced from an activation function such as Leaky ReLU which is less stable in a trainable transformation such as MSFC.

FIG. 6 is a schematic block diagram showing an example of functional modules of a multi-scale feature encoder 600, corresponding to the multi-scale feature encoder 550. Feature maps or tensors output at the split point may contain three feature maps L2, L1, and L0 at a size of (B, C2, h/32, 2/32), (B, C1, h/16, 2/16), and (B, C0, h/8, 2/8), respectively. In describing the size, B is the batch size, C2, C1, and C0 are the number of channels, and h and w are the height and width of the input image or video frame. The backbone CNN 4001 may take as input a video frame of resolution 1088×608 and produce three tensors, corresponding to three layers, with the following dimensions for a YOLOv3 network: [1, 1024, 19, 34], [1, 512, 38, 68], [1, 256, 76, 136]. Another example of the three tensors corresponding to three layers may be [1, 512, 34, 19], [1, 256, 68, 38], [1, 128, 136, 76] which are respectively separated at 79th network layer, 94th network layer, and 109th network layer in the CNN 4001. The tensors 115 are generated using a split point from each of layers 79, 94 and 109 of the neural network comprising the backbone 114 and head 150. In another example for YOLOv3, the tensors 115 are generated using a split point following the convolution layer at CBL layers for each of the layers 79, 94 and 109 of the neural network. In a software implementation of the JDE network, such as the one used in the VCM ad-hoc group object tracking feature anchor (ISO/IEC JTC 1/SC 29/WG 2 m59940), all layers of the network are enumerated and the indexes of the CBL layers 428, 468, 488 are 79, 94, and 109 respectively in this enumeration. Each tensor can have a different resolution to other tensors among the tensors 115. The resolution of each tensor can double in height and width between respective tensors. In forming the output tensors 115, the tensors 514, 524, and 534 provide a hierarchical representation of the frame data including data of feature maps for encoding to the bitstream. The separating points depend on the CNN310.

The multi-scale feature encoder 600 contains two blocks. The first block is multi-scale feature fusion MSFF block 608 and the second block is single scale feature compression (SSFC) encoder 650. The first tensor L2 451 is passed to an upsampler 610. The upsampler 610 upsamples the tensor 451 to produce a tensor 612 having a larger spatial scale, i.e., L2 451 at (h/32, w/32, 512) is upsampled to match the spatial scale of the larger tensor L1 461. The third feature map L0 491 passes through a downsampler 612. The downsampler 612 downsamples the tensor 491 and produces a tensor 614 having a smaller spatial scale, i.e., L0 491 at (h/8, w/8, 128) is downsampled to match the spatial scale of the smaller tensor 461.

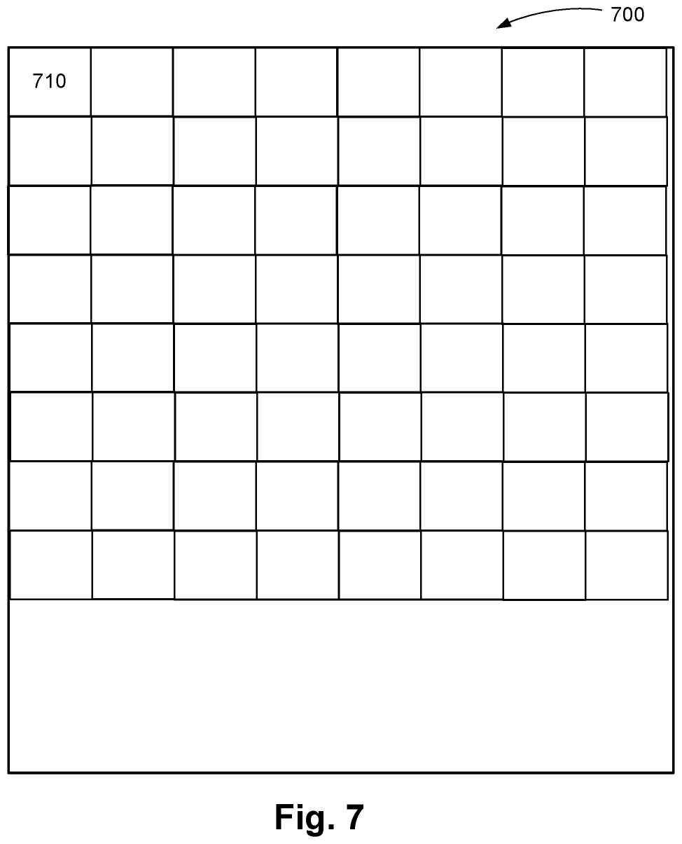

The three tensors 612, 461, 614 have the same spatial size and pass through a concatenation module 620 which merges all tensors to a single tensor 622 along the channel dimension. The merged tensor 622 is input to a squeeze and excite (SE) block 624. The SE block 624 is trained to adaptively alter the weighting of different channels in the tensor 622, based on the first fully-connected layer output. The first fully-connected layer output reduces each feature map for each channel to a single value The single value is passed through a non-linear activation unit (ReLU) to create a conditional representation of the unit, suitable for weighting of other channels. Restoration of the conditional channel to the full channel count is performed by a second fully-connected layer of the block 624. The SE block 624 is thus capable of extracting non-linear inter-channel correlation in producing a tensor 627 from the tensor 5622, to a greater extent than is possible purely with convolutional (linear) layers. The tensors 612, 461 and 614 contain 512, 256, and 128 channels, the tensor 622 contains 896 channels. The decorrelation achieved by the SE block 624 spans the tensor 627 containing 896 channels. The tensor 627 is passed to a convolutional layer 628. The convolutional layer 628 implements one or more convolutional layers to produce a combined tensor 629, with channel count reduced to F channels, typically 256 channels. Following the MSFF block 608, the SSFC encoder 650 is implemented under execution of the processor 205. Operation of the SSFC encoder 550 reduces the dimensionality of the combined tensor 629 to produce a compressed tensor 657. The combined tensor 629 is passed to a convolution layer 652 to produce a tensor 653. The tensor 653 has a channel count reduced from 256 to a smaller value C′, such as 64. The value 96 may also be used for C′, resulting in a larger area requirement for the packed frame, to be described with reference to FIG. 7. The tensor 653 is passed to a batch normalisation module 654 to produce a tensor 655. The batch normalised tensor 655 has the same dimensionality as the tensor 653. The tensor 655 is passed to a TanH layer 656. The TanH layer 656 implements a hyperbolic tangent (TanH) layer to produce the compressed tensor 657. Use of a hyperbolic tangent (TanH) layer compresses the dynamic range of values within the tensor 657 to [−1, 1], removing outlier values. The compressed tensor 657 has the same dimensionality as the tensors 653 and 655. The tensor 657 corresponds to the bottleneck tensor 117.

FIG. 6B shows a method 670 may be implemented using apparatus such as a configured FPGA, an ASIC, or an ASSP. Alternatively, as described below, the method 670 may be implemented by the source device 110, as one or more software code modules of the application programs 233, under execution of the processor 205. The software code modules of the application programs 233 implementing the method 600 may be resident, for example, in the hard disk drive 210 and/or the memory 206. The method 670 is repeated for each frame of video data produced by the video source 112. The method 670 may be stored on computer-readable storage medium and/or in the memory 206. The method 670 beings at a perform neural network first portion step 672.

At the step 672 the CNN backbone 114, under execution of the processor 205, performs neural network layers corresponding to the first portion of the neural network (CNN backbone 4001 shown in FIG. 4). The step 672 effectively implements the CNN backbone 114. For example, the CNN layers as described with reference to FIG. 5 may be performed to produce L2, L1, L0 tensors forming the tensors 115. The CNN backbone 114 performs the other modules (BN and LR modules) of the CBL modules 428, 468 to generates tensors (429 and 469) for the next backbone stage. The method 600 continues under control of the processor 205 from step 672 to a select tensors step 676.

At the step 676, the feature maps (tensors) L2, L1, L0 are extracted or selected. The tensors L2, L1 and L0 are selected from outputs of the first modules (convolutional modules) of the CBL modules 428, 468, and 488. In other words, the tensors 451, 461 and 491 are selected.

The steps 672 and 676 operate to acquire first tensors (115) related to the image data. Each of the first tensors acquired using the output of the backbone portion 114 of the neural network. As described above, the neural network includes at least one layer of a first type being the CBL layer. Each CBL layer has at least a convolutional module and a batch-normalization module, and each derived tensor is a tensor for which the convolutional module of one CBL layer has been performed but for which the batch-normalization module has not been performed.

The method 670 continues under control of the processor 205 from step 676 to a combine tensors step 680.

At the step 680, the MSFF module 608 of FIG. 6A, under execution of the processor 205, combines each tensor of the set of tensors, i.e., 451, 461, and 481, to produce the combined tensor 629. The downsample module 612 operates on the tensor having larger spatial scale, i.e., L0 491 at B, 128,h/8, w/8, downsampling to match the spatial scale of the smaller tensor, i.e., L1 524 at B, 256,h/8, w/8, producing the downscaled L0 tensor 614. The upsample module 610 operates on the tensor having smaller spatial scale, i.e., L2 451 at B,512,h/62, w/32, downsampling to match the spatial scale of the larger tensor, i.e., L1 461 at B, 256,h/8, w/8, producing upscaled L2 tensor 612. The concatenation module 620 performs a channel-wise concatenation of the tensors 612, 461, and 614 to produce the concatenated tensor 622, of dimensions B, 896, h/16, w/16. The concatenated tensor 522 is passed to the squeeze and excitation (SE) module 624 to produce the tensor 627. The SE module 624 sequentially performs a global pooling, a fully-connected layer with reduction in channel count, a rectified linear unit activation, a second fully-connected layer restoring the channel count, and a sigmoid activation function to produce a scaling tensor. The method 670 continues under control of the processor 205 from step 680 to an SSFC encode combined tensor step 680.

At the step 684, the SSFC encoder 650 is implemented under execution of the processor 205, as described in relation to FIG. 6A. Operation of the SSFC encoder 650 reduces the dimensionality of the combined tensor 629 to produce the compressed tensor 657.

The steps 680 and 684 operate to perform predetermined processing (such as MFSC) on the first tensors 115 to derive tensor 117, the number of dimensions of the data structure of the tensors 115 being larger than the number of dimensions of the data structure of tensor 117. The method 670 continues under control of the processor 205 from step 684 to a pack compressed tensors step 680.

At the step 688 the quantise and pack module 118, under execution of the processor 205, quantises the compressed tensor 657 (117) from the floating-point domain to the integer (sample) domain and packs the quantised tensors into a single monochrome video frame. An example single monochrome video frame 700 is shown in FIG. 7. The frame 700 corresponds to the frame data 119. The range of the compressed tensor 657 is [−1, 1] due to use of the TanH activation function at 656. The nature of TanH in removing outliers results in a distribution amenable to linear quantisation to the bit depth of the frame 700. Channels of the compressed tensor 657 are packed as feature maps of a particular size, such as a feature map 710 in the frame 700. Each channels of the compressed tensor 657 is packed as a feature maps in the frame 700. In arrangements with multiple compressed tensors within 657, such as described with reference to FIGS. 15A and 15B, packed feature maps of different tensors may differ in width and height. The method 670 continues under control of the processor 205 from step 688 to a compress frame step 692.

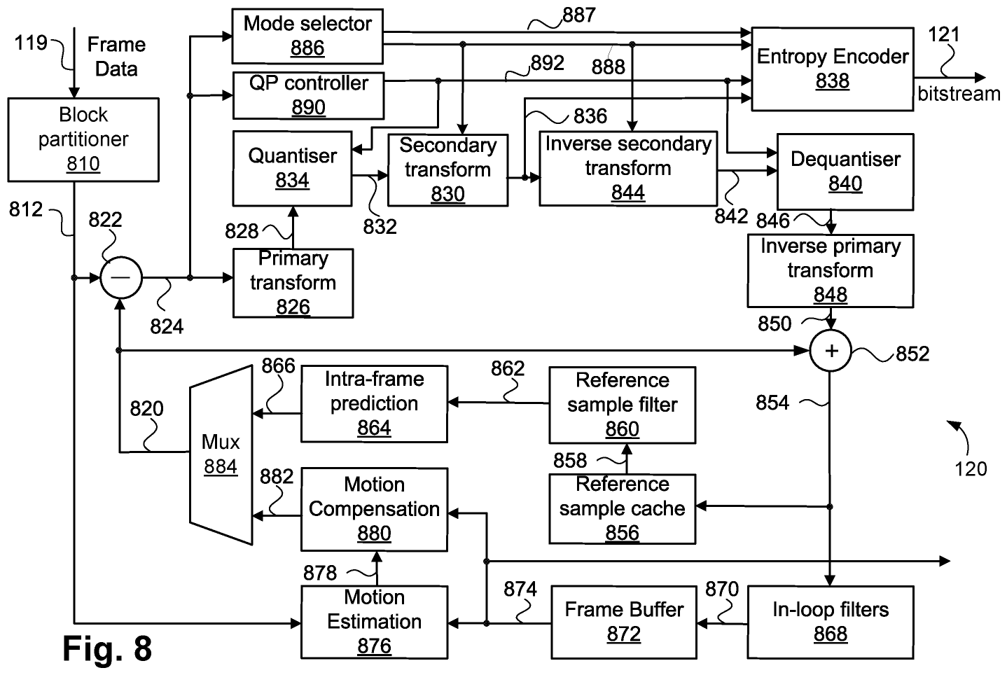

At the step 692 the feature map encoder 120, under execution of the processor 205, encodes the packed frame 119 (for example the frame 700) to produce the bitstream 121. Operation of the feature map encoder 120 is described with reference to FIG. 8. The steps 688 and 692 operate to encode the tensor 117 to the bitstream 121. The method 670 terminates on execution of step 692, with the FPN layers of an image frame 312 reduced in dimensionality and compressed into the video bitstream 121.

The arrangements described effectively divide the tensors produced by CNN backbone 114 into first and second sets of multiple tensors (also referred to as pluralities of tensors), the tensors in each set having different spatial resolution feature maps to one another. At the step 676 the bottleneck encoder 116, under execution of the processor 205, selects multiple tensors adjacent among the tensors 602 as a plurality of tensors.

FIG. 8 is a schematic block diagram showing functional modules of the video encoder 120, also referred to as a feature map encoder. The video encoder 120 encodes the packed frame 119, shown as the frame 700 in the example of FIG. 7, to produce the bitstream 121. Generally, data passes between functional modules within the video encoder 120 in groups of samples or coefficients, such as divisions of blocks into sub-blocks of a fixed size, or as arrays. The video encoder 120 may be implemented using a general-purpose computer system 200, as shown in FIGS. 2A and 2B, where the various functional modules may be implemented by dedicated hardware within the computer system 200, by software executable within the computer system 200 such as one or more software code modules of the software application program 233 resident on the hard disk drive 205 and being controlled in its execution by the processor 205. Alternatively, the video encoder 120 may be implemented by a combination of dedicated hardware and software executable within the computer system 200. The video encoder 120 and the described methods may alternatively be implemented in dedicated hardware, such as one or more integrated circuits performing the functions or sub functions of the described methods. Such dedicated hardware may include graphic processing units (GPUs), digital signal processors (DSPs), application-specific standard products (ASSPs), application-specific integrated circuits (ASICs), field programmable gate arrays (FPGAs) or one or more microprocessors and associated memories. In particular, the video encoder 120 comprises modules 810-890 which may each be implemented as one or more software code modules of the software application program 233.

Although the video encoder 120 of FIG. 8 is an example of a versatile video coding (VVC) video encoding pipeline, other video codecs may also be used to perform the processing stages described herein. The frame data 119 may be in any chroma format and bit depth supported by the profile in use, for example 4:0:0, 4:2:0 for the “Main 10” profile of the VVC standard, at eight (8) to ten (10) bits in sample precision.

A block partitioner 810 firstly divides the frame data 119 into CTUs, generally square in shape and configured such that a particular size for the CTUs is used. The maximum enabled size of the CTUs may be 32×32, 64×64, or 128×128 luma samples for example, configured by a ‘sps_log2_ctu_size_minus5’ syntax element present in the ‘sequence parameter set’. The CTU size also provides a maximum CU size, as a CTU with no further splitting will contain one CU. The block partitioner 810 further divides each CTU into one or more CBs according to a luma coding tree and a chroma coding tree. The luma channel may also be referred to as a primary colour channel. Each chroma channel may also be referred to as a secondary colour channel. The CBs have a variety of sizes, and may include both square and non-square aspect ratios. However, in the VVC standard, CBs, CUs, PUs, and TUs always have side lengths that are powers of two. Thus, a current CB, represented as 812, is output from the block partitioner 810, progressing in accordance with an iteration over the one or more blocks of the CTU, in accordance with the luma coding tree and the chroma coding tree of the CTU.

The CTUs resulting from the first division of the frame data 119 may be scanned in raster scan order and may be grouped into one or more ‘slices’. A slice may be an ‘intra’ (or ‘T’) slice. An intra slice (I slice) indicates that every CU in the slice is intra predicted. Generally, the first picture in a coded layer video sequence (CLVS) contains only I slices, and is referred to as an ‘intra picture’. The CLVS may contain periodic intra pictures, forming ‘random access points’ (i.e., intermediate frames in a video sequence upon which decoding can commence). Alternatively, a slice may be uni- or bi-predicted (‘P’ or ‘B’ slice, respectively), indicating additional availability of uni- and bi-prediction in the slice, respectively.

The video encoder 120 encodes sequences of pictures according to a picture structure. One picture structure is ‘low delay’, in which case pictures using inter-prediction may only reference pictures occurring previously in the sequence. Low delay enables each picture to be output as soon as the picture is decoded, in addition to being stored for possible reference by a subsequent picture. Another picture structure is ‘random access’, whereby the coding order of pictures differs from the display order. Random access allows inter-predicted pictures to reference other pictures that, although decoded, have not yet been output. A degree of picture buffering is needed so the reference pictures in the future in terms of display order are present in the decoded picture buffer, resulting in a latency of multiple frame.

When a chroma format other than 4:0:0 is in use, in an I slice, the coding tree of each CTU may diverge below the 64×64 level into two separate coding trees, one for luma and another for chroma. Use of separate trees allows different block structure to exist between luma and chroma within a luma 64×64 area of a CTU. For example, a large chroma CB may be collocated with numerous smaller luma CBs and vice versa. In a P or B slice, a single coding tree of a CTU defines a block structure common to luma and chroma. The resulting blocks of the single tree may be intra predicted or inter predicted.

In addition to a division of pictures into slices, pictures may also be divided into ‘tiles’. A tile is a sequence of CTUs covering a rectangular region of a picture. CTU scanning occurs in a raster-scan manner within each tile and progresses from one tile to the next. A slice can be either an integer number of tiles, or an integer number of consecutive rows of CTUs within a given tile.

For each CTU, the video encoder 120 operates in two stages. In the first stage (referred to as a ‘search’ stage), the block partitioner 810 tests various potential configurations of a coding tree. Each potential configuration of a coding tree has associated ‘candidate’ CBs. The first stage involves testing various candidate CBs to select CBs providing relatively high compression efficiency with relatively low distortion. The testing generally involves a Lagrangian optimisation whereby a candidate CB is evaluated based on a weighted combination of rate (i.e., coding cost) and distortion (i.e., error with respect to the input frame data 119). ‘Best’ candidate CBs (i.e., the CBs with the lowest evaluated rate/distortion) are selected for subsequent encoding into the bitstream 121. Included in evaluation of candidate CBs is an option to use a CB for a given area or to further split the area according to various splitting options and code each of the smaller resulting areas with further CBs, or split the areas even further. As a consequence, both the coding tree and the CBs themselves are selected in the search stage.

The video encoder 120 produces a prediction block (PB), indicated by an arrow 820, for each CB, for example, CB 812. The PB 820 is a prediction of the contents of the associated CB 812. A subtracter module 822 produces a difference, indicated as 824 (or ‘residual’, referring to the difference being in the spatial domain), between the PB 820 and the CB 812. The difference 824 is a block-size difference between corresponding samples in the PB 820 and the CB 812. The difference 824 is transformed, quantised and represented as a transform block (TB), indicated by an arrow 836. The PB 820 and associated TB 836 are typically chosen from one of many possible candidate CBs, for example, based on evaluated cost or distortion.

A candidate coding block (CB) is a CB resulting from one of the prediction modes available to the video encoder 120 for the associated PB and the resulting residual. When combined with the predicted PB in the video encoder 120, the TB 836 reduces the difference between a decoded CB and the original CB 812 at the expense of additional signalling in a bitstream.

Each candidate coding block (CB), that is prediction block (PB) in combination with a transform block (TB), thus has an associated coding cost (or ‘rate’) and an associated difference (or ‘distortion’). The distortion of the CB is typically estimated as a difference in sample values, such as a sum of absolute differences (SAD), a sum of squared differences (SSD) or a Hadamard transform applied to the differences. The estimate resulting from each candidate PB may be determined by a mode selector 886 using the difference 824 to determine a prediction mode 887. The prediction mode 887 indicates the decision to use a particular prediction mode for the current CB, for example, intra-frame prediction or inter-frame prediction. Estimation of the coding costs associated with each candidate prediction mode and corresponding residual coding may be performed at significantly lower cost than entropy coding of the residual. Accordingly, a number of candidate modes may be evaluated to determine an optimum mode in a rate-distortion sense even in a real-time video encoder.

Determining an optimum mode in terms of rate-distortion is typically achieved using a variation of Lagrangian optimisation.

Lagrangian or similar optimisation processing can be employed to both select an optimal partitioning of a CTU into CBs (by the block partitioner 810) as well as the selection of a best prediction mode from a plurality of possibilities. Through application of a Lagrangian optimisation process of the candidate modes in the mode selector module 886, the intra prediction mode with the lowest cost measurement is selected as the ‘best’ mode. The lowest cost mode includes a selected secondary transform index 888, which is also encoded in the bitstream 121 by an entropy encoder 838.

In the second stage of operation of the video encoder 120 (referred to as a ‘coding’ stage), an iteration over the determined coding tree(s) of each CTU is performed in the video encoder 120. For a CTU using separate trees, for each 64×64 luma region of the CTU, a luma coding tree is firstly encoded followed by a chroma coding tree. Within the luma coding tree, only luma CBs are encoded and within the chroma coding tree only chroma CBs are encoded. For a CTU using a shared tree, a single tree describes the CUs (i.e., the luma CBs and the chroma CBs) according to the common block structure of the shared tree.

The entropy encoder 838 supports bitwise coding of syntax elements using variable-length and fixed-length codewords, and an arithmetic coding mode for syntax elements. Portions of the bitstream such as ‘parameter sets’, for example, sequence parameter set (SPS) and picture parameter set (PPS) use a combination of fixed-length codewords and variable-length codewords. Slices, also referred to as contiguous portions, have a slice header that uses variable length coding followed by slice data, which uses arithmetic coding. The slice header defines parameters specific to the current slice, such as slice-level quantisation parameter offsets. The slice data includes the syntax elements of each CTU in the slice. Use of variable length coding and arithmetic coding requires sequential parsing within each portion of the bitstream. The portions may be delineated with a start code to form ‘network abstraction layer units’ or ‘NAL units’. Arithmetic coding is supported using a context-adaptive binary arithmetic coding process.

Arithmetically coded syntax elements consist of sequences of one or more ‘bins’. Bins, like bits, have a value of ‘0’ or ‘1’. However, bins are not encoded in the bitstream 121 as discrete bits. Bins have an associated predicted (or ‘likely’ or ‘most probable’) value and an associated probability, known as a ‘context’. When the actual bin to be coded matches the predicted value, a ‘most probable symbol’ (MPS) is coded. Coding a most probable symbol is relatively inexpensive in terms of consumed bits in the bitstream 121, including costs that amount to less than one discrete bit. When the actual bin to be coded mismatches the likely value, a ‘least probable symbol’ (LPS) is coded. Coding a least probable symbol has a relatively high cost in terms of consumed bits. The bin coding techniques enable efficient coding of bins where the probability of a ‘0’ versus a ‘1’ is skewed. For a syntax element with two possible values (i.e., a ‘flag’), a single bin is adequate. For syntax elements with many possible values, a sequence of bins is needed.

The presence of later bins in the sequence may be determined based on the value of earlier bins in the sequence. Additionally, each bin may be associated with more than one context. The selection of a particular context may be dependent on earlier bins in the syntax element, the bin values of neighbouring syntax elements (i.e., those from neighbouring blocks) and the like. Each time a context-coded bin is encoded, the context that was selected for that bin (if any) is updated in a manner reflective of the new bin value. As such, the binary arithmetic coding scheme is said to be adaptive.

Also supported by the entropy encoder 838 are bins that lack a context, referred to as “bypass bins”. Bypass bins are coded assuming an equiprobable distribution between a ‘0’ and a ‘1’. Thus, each bin has a coding cost of one bit in the bitstream 121. The absence of a context saves memory and reduces complexity, and thus bypass bins are used where the distribution of values for the particular bin is not skewed. One example of an entropy coder employing context and adaption is known in the art as CABAC (context adaptive binary arithmetic coder) and many variants of this coder have been employed in video coding.

The entropy encoder 838 encodes a quantisation parameter 892 and, if in use for the current CB, the LFNST index 888, using a combination of context-coded and bypass-coded bins. The quantisation parameter 892 is encoded using a ‘delta QP’ generated by a QP controller module 890. The delta QP is signalled at most once in each area known as a ‘quantisation group’. The quantisation parameter 892 is applied to residual coefficients of the luma CB. An adjusted quantisation parameter is applied to the residual coefficients of collocated chroma CBs. The adjusted quantisation parameter may include mapping from the luma quantisation parameter 892 according to a mapping table and a CU-level offset, selected from a list of offsets. The secondary transform index 888 is signalled when the residual associated with the transform block includes significant residual coefficients only in those coefficient positions subject to transforming into primary coefficients by application of a secondary transform.

Residual coefficients of each TB associated with a CB are coded using a residual syntax. The residual syntax is designed to efficiently encode coefficients with low magnitudes, using mainly arithmetically coded bins to indicate significance of coefficients, along with lower-valued magnitudes and reserving bypass bins for higher magnitude residual coefficients. Accordingly, residual blocks comprising very low magnitude values and sparse placement of significant coefficients are efficiently compressed. Moreover, two residual coding schemes are present. A regular residual coding scheme is optimised for TBs with significant coefficients predominantly located in the upper-left corner of the TB, as is seen when a transform is applied. A transform-skip residual coding scheme is available for TBs where a transform is not performed and is able to efficiently encode residual coefficients regardless of their distribution throughout the TB.

A multiplexer module 884 outputs the PB 820 from an intra-frame prediction module 864 according to the determined best intra prediction mode, selected from the tested prediction mode of each candidate CB. The candidate prediction modes need not include every conceivable prediction mode supported by the video encoder 120. Intra prediction falls into three types, first, “DC intra prediction”, which involves populating a PB with a single value representing the average of nearby reconstructed samples; second, “planar intra prediction”, which involves populating a PB with samples according to a plane, with a DC offset and a vertical and horizontal gradient being derived from nearby reconstructed neighbouring samples. The nearby reconstructed samples typically include a row of reconstructed samples above the current PB, extending to the right of the PB to an extent and a column of reconstructed samples to the left of the current PB, extending downwards beyond the PB to an extent; and, third, “angular intra prediction”, which involves populating a PB with reconstructed neighbouring samples filtered and propagated across the PB in a particular direction (or ‘angle’). In VVC, sixty-five (65) angles are supported, with rectangular blocks able to utilise additional angles, not available to square blocks, to produce a total of eighty-seven (87) angles.

A fourth type of intra prediction is available to chroma PBs, whereby the PB is generated from collocated luma reconstructed samples according to a ‘cross-component linear model’ (CCLM) mode. Three different CCLM modes are available, each mode using a different model derived from the neighbouring luma and chroma samples. The derived model is used to generate a block of samples for the chroma PB from the collocated luma samples. Luma blocks may be intra predicted using a matrix multiplication of the reference samples using one matrix selected from a predefined set of matrices. This matrix intra prediction (MIP) achieves gain by using matrices trained on a large set of video data, with the matrices representing relationships between reference samples and a predicted block that are not easily captured in angular, planar, or DC intra prediction modes.

The module 864 may also produce a prediction unit by copying a block from nearby the current frame using an ‘intra block copy’ (IBC) method. The location of the reference block is constrained to an area equivalent to one CTU, divided into 64×64 regions known as VPDUs, with the area covering the processed VPDUs of the current CTU and VPDUs of the previous CTU(s) within each row or CTUs and within each slice or tile up to the area limit corresponding to one 128×128 luma samples, regardless of the configured CTU size for the bitstream. This area is known as an ‘IBC virtual buffer’ and limits the IBC reference area, thus limiting the required storage. The IBC buffer is populated with reconstructed samples 854 (i.e., prior to loop filtering), and so a separate buffer to a frame buffer 872 is needed. When the CTU size is 128×128 the virtual buffer includes samples only from the CTU adjacent and to the left of the current CTU. When the CTU size is 32×32 or 64×64 the virtual buffer includes CTUs from up to the four or sixteen CTUs to the left of the current CTU. Regardless of the CTU size, access to neighbouring CTUs for obtaining samples for IBC reference blocks is constrained by boundaries such as edges of pictures, slices, or tiles. Especially for feature maps of FPN layers having smaller dimensions, use of a CTU size such as 32×32 or 64×64 results in a reference area more aligned to cover a set of previous feature maps. Where feature map placement is ordered based on SAD, SSE or other difference metric, access to similar feature maps for IBC prediction offers coding efficient advantage.

The residual for a predicted block when encoding feature map data is different to the residual seen for natural video. Such natural video is typically captured by an imaging sensor, or screen content, as generally seen in operating system user interfaces and the like. Feature map residuals tend to contain much detail, which is amenable to transform skip coding more than predominantly low-frequency coefficients of various transforms. Experiments show that the feature map residual has enough local similarity to benefit from transform coding. However, the distribution of feature map residual coefficients is not clustered towards the DC (top-left) coefficient of a transform block. In other words, sufficient correlation exists for a transform to show gain when encoding feature map data and this is true also for when intra block copy is used to produce prediction blocks for the feature map data. Accordingly, a Hadamard cost estimate may be used when evaluating residuals resulting from candidate block vectors for intra block copy when encoding feature map data, instead of relying solely on a SAD or SSD cost estimate. SAD or SSD cost estimates tend to select block vectors with residuals more amenable to transform skip coding and may miss block vectors with residuals that would be compactly encoded using transforms. The multiple transform selection (MTS) tool of the VVC standard may be used when encoding feature map data so that, in addition to the DCT-2 transform, combinations of DST-7 and DCT-8 transforms are available horizontally and vertically for residual encoding.

An intra-predicted luma coding block may be partitioned into a set of equal-sized prediction blocks, either vertically or horizontally, which each block having a minimum area of sixteen (16) luma samples. This intra sub-partition (ISP) approach enables separate transform blocks to contribute to prediction block generation from one sub-partition to the next sub-partition in the luma coding block, improving compression efficiency.

Where previously reconstructed neighbouring samples are unavailable, for example at the edge of the frame, a default half-tone value of one half the range of the samples is used. For example, for 10-bit video a value of five-hundred and twelve (512) is used. As no previous samples are available for a CB located at the top-left position of a frame, angular and planar intra-prediction modes produce the same output as the DC prediction mode (i.e. a flat plane of samples having the half-tone value as magnitude).

For inter-frame prediction a prediction block 882 is produced using samples from one or two frames preceding the current frame in the coding order frames in the bitstream by a motion compensation module 880 and output as the PB 820 by the multiplexer module 884. Moreover, for inter-frame prediction, a single coding tree is typically used for both the luma channel and the chroma channels. The order of coding frames in the bitstream may differ from the order of the frames when captured or displayed. When one frame is used for prediction, the block is said to be ‘uni-predicted’ and has one associated motion vector. When two frames are used for prediction, the block is said to be ‘bi-predicted’ and has two associated motion vectors. For a P slice, each CU may be intra predicted or uni-predicted. For a B slice, each CU may be intra predicted, uni-predicted, or bi-predicted.

Frames are typically coded using a ‘group of pictures’ (GOP) structure, enabling a temporal hierarchy of frames. Frames may be divided into multiple slices, each of which encodes a portion of the frame. A temporal hierarchy of frames allows a frame to reference a preceding and a subsequent picture in the order of displaying the frames. The images are coded in the order necessary to ensure the dependencies for decoding each frame are met. An affine inter prediction mode is available where instead of using one or two motion vectors to select and filter reference sample blocks for a prediction unit, the prediction unit is divided into multiple smaller blocks and a motion field is produced so each smaller block has a distinct motion vector. The motion field uses the motion vectors of nearby points to the prediction unit as ‘control points’. Affine prediction allows coding of motion different to translation with less need to use deeply split coding trees. A bi-prediction mode available to VVC performs a geometric blend of the two reference blocks along a selected axis, with angle and offset from the centre of the block signalled. This geometric partitioning mode (“GPM”) allows larger coding units to be used along the boundary between two objects, with the geometry of the boundary coded for the coding unit as an angle and centre offset. Motion vector differences, instead of using cartesian (x, y) offset, may be coded as a direction (up/down/left/right) and a distance, with a set of power-of-two distances supported. The motion vector predictor is obtained from a neighbouring block (‘merge mode’) as if no offset is applied. The current block will share the same motion vector as the selected neighbouring block.

The samples are selected according to a motion vector 878 and a reference picture index. The motion vector 878 and reference picture index applies to all colour channels and thus inter prediction is described primarily in terms of operation upon PUs rather than PBs. The decomposition of each CTU into one or more inter-predicted blocks is described with a single coding tree. Inter prediction methods may vary in the number of motion parameters and their precision. Motion parameters typically comprise a reference frame index, indicating which reference frame(s) from lists of reference frames are to be used plus a spatial translation for each of the reference frames, but may include more frames, special frames, or complex affine parameters such as scaling and rotation. In addition, a pre-determined motion refinement process may be applied to generate dense motion estimates based on referenced sample blocks.

Having determined and selected the PB 820 and subtracted the PB 820 from the original sample block at the subtractor 822, a residual with lowest coding cost, represented as 824, is obtained and subjected to lossy compression. The lossy compression process comprises the steps of transformation, quantisation and entropy coding. A forward primary transform module 826 applies a forward transform to the difference 824, converting the difference 824 from the spatial domain to the frequency domain, and producing primary transform coefficients represented by an arrow 828. The largest primary transform size in one dimension is either a 32-point DCT-2 or a 64-point DCT-2 transform, configured by a ‘sps_max_luma_transform_size_64_flag’ in the sequence parameter set. If the CB being encoded is larger than the largest supported primary transform size expressed as a block size (e.g. 64×64 or 32×32), the primary transform 826 is applied in a tiled manner to transform all samples of the difference 824. Where a non-square CB is used, tiling is also performed using the largest available transform size in each dimension of the CB. For example, when a maximum transform size of thirty-two (32) is used, a 64×16 CB uses two 32×16 primary transforms arranged in a tiled manner. When a CB is larger in size than the maximum supported transform size, the CB is filled with TBs in a tiled manner. For example, a 128×128 CB with 64-pt transform maximum size is filled with four 64×64 TBs in a 2×2 arrangement. A 64×128 CB with a 32-pt transform maximum size is filled with eight 32×32 TBs in a 2×4 arrangement.

Application of the transform 826 results in multiple TBs for the CB. Where each application of the transform operates on a TB of the difference 824 larger than 32×32, e.g. 64×64, all resulting primary transform coefficients 828 outside of the upper-left 32×32 area of the TB are set to zero (i.e., discarded). The remaining primary transform coefficients 828 are passed to a quantiser module 834. The primary transform coefficients 828 are quantised according to the quantisation parameter 892 associated with the CB to produce primary transform coefficients 832. In addition to the quantisation parameter 892, the quantiser module 834 may also apply a ‘scaling list’ to allow non-uniform quantisation within the TB by further scaling residual coefficients according to their spatial position within the TB. The quantisation parameter 892 may differ for a luma CB versus each chroma CB. The primary transform coefficients 832 are passed to a forward secondary transform module 830 to produce the transform coefficients represented by the arrow 836 by performing either a non-separable secondary transform (NSST) operation or bypassing the secondary transform. The forward primary transform is typically separable, transforming a set of rows and then a set of columns of each TB. The forward primary transform module 826 uses either a type-II discrete cosine transform (DCT-2) in the horizontal and vertical directions, or bypass of the transform horizontally and vertically, or combinations of a type-VII discrete sine transform (DST-7) and a type-VIII discrete cosine transform (DCT-8) in either horizontal or vertical directions for luma TBs not exceeding 16 samples in width and height. Use of combinations of a DST-7 and DCT-8 is referred to as ‘multi transform selection set’ (MTS) in the VVC standard.

The forward secondary transform of the module 830 is generally a non-separable transform, which is only applied for the residual of intra-predicted CUs and may nonetheless also be bypassed. The forward secondary transform operates either on sixteen (16) samples (arranged as the upper-left 4×4 sub-block of the primary transform coefficients 828) or forty-eight (48) samples (arranged as three 4×4 sub-blocks in the upper-left 8×8 coefficients of the primary transform coefficients 828) to produce a set of secondary transform coefficients. The set of secondary transform coefficients may be fewer in number than the set of primary transform coefficients from which they are derived. Due to application of the secondary transform to only a set of coefficients adjacent to each other and including the DC coefficient, the secondary transform is referred to as a ‘low frequency non-separable secondary transform’ (LFNST). Such secondary transforms may be obtained through a training process and due to their non-separable nature and trained origin, exploit additional redundancy in the residual signal not able to be captured by separable transforms such as variants of DCT and DST. Moreover, when the LFNST is applied, all remaining coefficients in the TB are zero, both in the primary transform domain and the secondary transform domain.

The quantisation parameter 892 is constant for a given TB and thus results in a uniform scaling for the production of residual coefficients in the primary transform domain for a TB. The quantisation parameter 892 may vary periodically with a signalled ‘delta quantisation parameter’. The delta quantisation parameter (delta QP) is signalled once for CUs contained within a given area, referred to as a ‘quantisation group’. If a CU is larger than the quantisation group size, delta QP is signalled once with one of the TBs of the CU. That is, the delta QP is signalled by the entropy encoder 838 once for the first quantisation group of the CU and not signalled for any subsequent quantisation groups of the CU. A non-uniform scaling is also possible by application of a ‘quantisation matrix’, whereby the scaling factor applied for each residual coefficient is derived from a combination of the quantisation parameter 892 and the corresponding entry in a scaling matrix. The scaling matrix may have a size that is smaller than the size of the TB, and when applied to the TB a nearest neighbour approach is used to provide scaling values for each residual coefficient from a scaling matrix smaller in size than the TB size. The residual coefficients 836 are supplied to the entropy encoder 838 for encoding in the bitstream 121. Typically, the residual coefficients of each TB with at least one significant residual coefficient of the TU are scanned to produce an ordered list of values, according to a scan pattern. The scan pattern generally scans the TB as a sequence of 4×4 ‘sub-blocks’, providing a regular scanning operation at the granularity of 4×4 sets of residual coefficients, with the arrangement of sub-blocks dependent on the size of the TB. The scan within each sub-block and the progression from one sub-block to the next typically follow a backward diagonal scan pattern. Additionally, the quantisation parameter 892 is encoded into the bitstream 121 using a delta QP syntax element, and a slice QP for the initial value in a given slice or subpicture and the secondary transform index 888 is encoded in the bitstream 121.

As described above, the video encoder 120 needs access to a frame representation corresponding to the decoded frame representation seen in the video decoder. Thus, the residual coefficients 836 are passed through an inverse secondary transform module 844, operating in accordance with the secondary transform index 888 to produce intermediate inverse transform coefficients, represented by an arrow 842. The intermediate inverse transform coefficients 842 are inverse quantised by a dequantiser module 840 according to the quantisation parameter 892 to produce inverse transform coefficients, represented by an arrow 846. The dequantiser module 840 may also perform an inverse non-uniform scaling of residual coefficients using a scaling list, corresponding to the forward scaling performed in the quantiser module 834. The inverse transform coefficients 846 are passed to an inverse primary transform module 848 to produce residual samples, represented by an arrow 850, of the TU. The inverse primary transform module 848 applies DCT-2 transforms horizontally and vertically, constrained by the maximum available transform size as described with reference to the forward primary transform module 826. The types of inverse transform performed by the inverse secondary transform module 844 correspond with the types of forward transform performed by the forward secondary transform module 830. The types of inverse transform performed by the inverse primary transform module 848 correspond with the types of primary transform performed by the primary transform module 826. A summation module 852 adds the residual samples 850 and the PU 820 to produce reconstructed samples (indicated by the arrow 854) of the CU.

The reconstructed samples 854 are passed to a reference sample cache 856 and an in-loop filters module 868. The reference sample cache 856, typically implemented using static RAM on an ASIC to avoid costly off-chip memory access, provides minimal sample storage needed to satisfy the dependencies for generating intra-frame PBs for subsequent CUs in the frame. The minimal dependencies typically include a ‘line buffer’ of samples along the bottom of a row of CTUs, for use by the next row of CTUs and column buffering the extent of which is set by the height of the CTU. The reference sample cache 856 supplies reference samples (represented by an arrow 858) to a reference sample filter 860. The sample filter 860 applies a smoothing operation to produce filtered reference samples (indicated by an arrow 862). The filtered reference samples 862 are used by an intra-frame prediction module 864 to produce an intra-predicted block of samples, represented by an arrow 866. For each candidate intra prediction mode the intra-frame prediction module 864 produces a block of samples, that is 866. The block of samples 866 is generated by the module 864 using techniques such as DC, planar or angular intra prediction. The block of samples 866 may also be produced using a matrix-multiplication approach with neighbouring reference sample as input and a matrix selected from a set of matrices by the video encoder 120, with the selected matrix signalled in the bitstream 121 using an index to identify which matrix of the set of matrices is to be used by the video decoder 144.

The in-loop filters module 868 applies several filtering stages to the reconstructed samples 854. The filtering stages include a ‘deblocking filter’ (DBF) which applies smoothing aligned to the CU boundaries to reduce artefacts resulting from discontinuities. Another filtering stage present in the in-loop filters module 868 is an ‘adaptive loop filter’ (ALF), which applies a Wiener-based adaptive filter to further reduce distortion. A further available filtering stage in the in-loop filters module 868 is a ‘sample adaptive offset’ (SAO) filter. The SAO filter operates by firstly classifying reconstructed samples into one or multiple categories and, according to the allocated category, applying an offset at the sample level.

Filtered samples, represented by an arrow 870, are output from the in-loop filters module 868. The filtered samples 870 are stored in the frame buffer 872. The frame buffer 872 typically has the capacity to store several (e.g., up to sixteen (16)) pictures and thus is stored in the memory 206. The frame buffer 872 is not typically stored using on-chip memory due to the large memory consumption required. As such, access to the frame buffer 872 is costly in terms of memory bandwidth. The frame buffer 872 provides reference frames (represented by an arrow 874) to a motion estimation module 876 and the motion compensation module 880.

The motion estimation module 876 estimates a number of ‘motion vectors’ (indicated as 878), each being a Cartesian spatial offset from the location of the present CB, referencing a block in one of the reference frames in the frame buffer 872. A filtered block of reference samples (represented as 882) is produced for each motion vector. The filtered reference samples 882 form further candidate modes available for potential selection by the mode selector 886. Moreover, for a given CU, the PU 820 may be formed using one reference block (‘uni-predicted’) or may be formed using two reference blocks (‘bi-predicted’). For the selected motion vector, the motion compensation module 880 produces the PB 820 in accordance with a filtering process supportive of sub-pixel accuracy in the motion vectors. As such, the motion estimation module 876 (which operates on many candidate motion vectors) may perform a simplified filtering process compared to that of the motion compensation module 880 (which operates on the selected candidate only) to achieve reduced computational complexity. When the video encoder 120 selects inter prediction for a CU the motion vector 878 is encoded into the bitstream 121.

Although the video encoder 120 of FIG. 8 is described with reference to versatile video coding (VVC), other video coding standards or implementations may also employ the processing stages of modules 810-890. The frame data 119 (and bitstream 121) may also be read from (or written to) memory 206, the hard disk drive 210, a CD-ROM, a Blu-ray disk™ or other computer readable storage medium. Additionally, the frame data 119 (and bitstream 121) may be received from (or transmitted to) an external source, such as a server connected to the communications network 220 or a radio-frequency receiver. The communications network 220 may provide limited bandwidth, necessitating the use of rate control in the video encoder 120 to avoid saturating the network at times when the frame data 119 is difficult to compress. Moreover, the bitstream 121 may be constructed from one or more slices, representing spatial sections (collections of CTUs) of the frame data 119, produced by one or more instances of the video encoder 120, operating in a co-ordinated manner under control of the processor 205. The bitstream 121 may also contain one slice that corresponds to one subpicture to be output as a collection of subpictures forming one picture, each being independently encodable and independently decodable with respect to any of the other slices or subpictures in the picture.

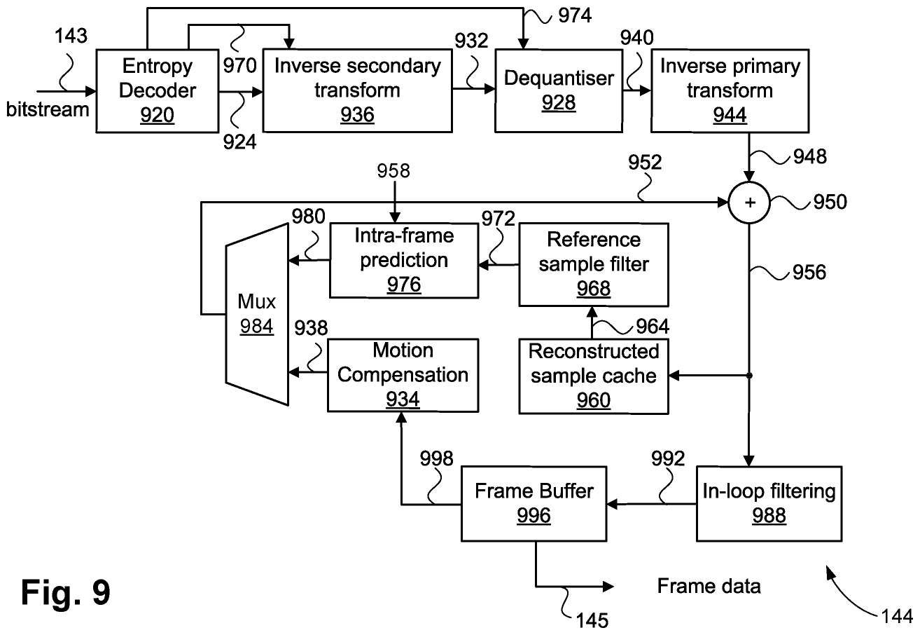

The video decoder 144, also referred to as a feature map decoder, is shown in FIG. 9. Although the video decoder 144 of FIG. 9 is an example of a versatile video coding (VVC) video decoding pipeline, other video codecs may also be used to perform the processing stages described herein. As shown in FIG. 9, the bitstream 143 is input to the video decoder 144. The bitstream 143 may be read from memory 206, the hard disk drive 210, a CD-ROM, a Blu-ray disk™ or other non-transitory computer readable storage medium. Alternatively, the bitstream 143 may be received from an external source such as a server connected to the communications network 220 or a radio-frequency receiver. The bitstream 143 contains encoded syntax elements representing the captured frame data to be decoded.

An entropy decoder module 920 applies an arithmetic coding algorithm, for example ‘context adaptive binary arithmetic coding’ (CABAC), to decode syntax elements from the bitstream 143. The decoded syntax elements are used to reconstruct parameters within the video decoder 144. Parameters include residual coefficients (represented by an arrow 924), a quantisation parameter 974, a secondary transform index 970, and mode selection information such as an intra prediction mode (represented by an arrow 958). The mode selection information also includes information such as motion vectors, and the partitioning of each CTU into one or more CBs. Parameters are used to generate PBs, typically in combination with sample data from previously decoded CBs.

The residual coefficients 924 are passed to an inverse secondary transform module 936 where either a secondary transform is applied or no operation is performed (bypass) according to a secondary transform index. The inverse secondary transform module 936 produces reconstructed transform coefficients 932, that is primary transform domain coefficients, from secondary transform domain coefficients. The reconstructed transform coefficients 932 are input to a dequantiser module 928. The dequantiser module 928 performs inverse quantisation (or ‘scaling’) on the residual coefficients 932, that is, in the primary transform coefficient domain, to create reconstructed intermediate transform coefficients, represented by an arrow 940, according to the quantisation parameter 974. The dequantiser module 928 may also apply a scaling matrix to provide non-uniform dequantization within the TB, corresponding to operation of the dequantiser module 840. Should use of a non-uniform inverse quantisation matrix be indicated in the bitstream 143, the video decoder 144 reads a quantisation matrix from the bitstream 143 as a sequence of scaling factors and arranges the scaling factors into a matrix. The inverse scaling uses the quantisation matrix in combination with the quantisation parameter to create the reconstructed intermediate transform coefficients 940.

The reconstructed transform coefficients 940 are passed to an inverse primary transform module 944. The module 944 transforms the coefficients 940 from the frequency domain back to the spatial domain. The inverse primary transform module 944 applies inverse DCT-2 transforms horizontally and vertically, constrained by the maximum available transform size as described with reference to the forward primary transform module 726. The result of operation of the module 944 is a block of residual samples, represented by an arrow 948. The block of residual samples 948 is equal in size to the corresponding CB. The residual samples 948 are supplied to a summation module 950.

At the summation module 950 the residual samples 948 are added to a decoded PB (represented as 952) to produce a block of reconstructed samples, represented by an arrow 956. The reconstructed samples 956 are supplied to a reconstructed sample cache 960 and an in-loop filtering module 988. The in-loop filtering module 988 produces reconstructed blocks of frame samples, represented as 992. The frame samples 992 are written to a frame buffer 996.

The reconstructed sample cache 960 operates similarly to the reconstructed sample cache 856 of the video encoder 120. The reconstructed sample cache 960 provides storage for reconstructed samples needed to intra predict subsequent CBs without the memory 206 (e.g., by using the data 232 instead, which is typically on-chip memory). Reference samples, represented by an arrow 964, are obtained from the reconstructed sample cache 960 and supplied to a reference sample filter 968 to produce filtered reference samples indicated by arrow 972. The filtered reference samples 972 are supplied to an intra-frame prediction module 976. The module 976 produces a block of intra-predicted samples, represented by an arrow 980, in accordance with the intra prediction mode parameter 958 signalled in the bitstream 143 and decoded by the entropy decoder 920. The intra prediction module 976 supports the modes of the module 764, including IBC and MIP. The block of samples 980 is generated using modes such as DC, planar or angular intra prediction.

When the prediction mode of a CB is indicated to use intra prediction in the bitstream 143, the intra-predicted samples 980 form the decoded PB 952 via a multiplexor module 984. Intra prediction produces a prediction block (PB) of samples, which is a block in one colour component, derived using ‘neighbouring samples’ in the same colour component. The neighbouring samples are samples adjacent to the current block and by virtue of being preceding in the block decoding order have already been reconstructed. Where luma and chroma blocks are collocated, the luma and chroma blocks may use different intra prediction modes. However, the two chroma CBs share the same intra prediction mode.

When the prediction mode of the CB is indicated to be inter prediction in the bitstream 143, a motion compensation module 934 produces a block of inter-predicted samples, represented as 938. The block of inter-predicted samples 938 are produced using a motion vector, decoded from the bitstream 143 by the entropy decoder 920, and reference frame index to select and filter a block of samples 998 from the frame buffer 996. The block of samples 998 is obtained from a previously decoded frame stored in the frame buffer 996. For bi-prediction, two blocks of samples are produced and blended together to produce samples for the decoded PB 952. The frame buffer 996 is populated with filtered block data 992 from the in-loop filtering module 988. As with the in-loop filtering module 868 of the video encoder 120, the in-loop filtering module 988 applies any of the DBF, the ALF and SAO filtering operations. Generally, the motion vector is applied to both the luma and chroma channels, although the filtering processes for sub-sample interpolation in the luma and chroma channel are different. Frames from the frame buffer 996 are output as decoded frames 145.

Not shown in FIGS. 8 and 9 is a module for pre-processing video prior to encoding and postprocessing video after decoding to shift sample values such that a more uniform usage of the range of sample values within each chroma channel is achieved. A multi-segment linear model is derived in the video encoder 120 and signalled in the bitstream for use by the video decoder 804 to undo the sample shifting. This linear-model chroma scaling (LMCS) tool provides compression benefit for particular colour spaces and content that have some nonuniformity, especially utilisation of a limited range, in their utilisation of the sample space that may result in higher quality loss from application of quantisation.

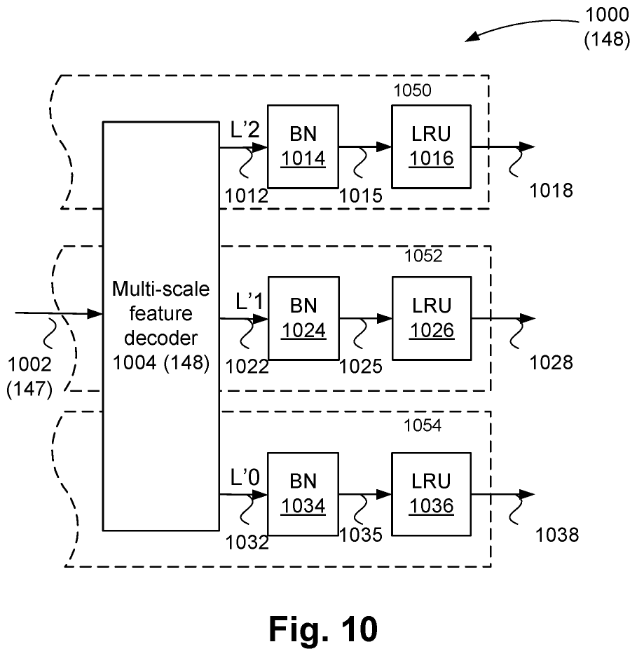

FIG. 10 is a schematic block diagram showing an example architecture 1000 of functional modules performing decoding s as implemented in the bottleneck decoder 148 and the head CNN 150. The architecture 1000 includes a multi-scale feature decoder 1004, a portion of a CBL decoder block 1050, a portion of a CBL decoder block 1052 and a portion of a CBL decoder block 1054. The CBL 1050 can combines with the portion 450 to perform the CBL layer 428 in an end-to-end network. The decoder block 1052 can combine with the block 460 to perform the CBL layer 448 in an end-to-end network. The decoder block 1054 can combine with the block 490 to perform the CBL layer 488 in an end-to-end network.

An input tensor 1002 from the unpack and inverse quantise 146 and corresponds to the tensor 147. The input 1002 passes through the multi-scale feature decoder 1004 to produce three tensors L′2 1012, L′1 1022, and L′0 1032. The three tensors L′2, L′1, and L′0 have the same dimensions with the tensor L2 451, L1 461 and L0 491 respectively.

The tensor L′2 passes through a batch normalization 1014 of the block 1050 to produce a tensor 1015. The tensor 1015 is input to a Leaky ReLU module 1016 of the block 1050 to produce a tensor 1018. The tensor L′1 passes through a batch normalization 1024 of the block 1052 to produce a tensor 1025. The tensor 1025 is input to a Leaky ReLU block 1026 of the block 1052 to produce a tensor 1028. The tensor L′0 passes through a batch normalization 1034 of the block 1054 to produce a tensor 1035. The tensor 1035 is input to a Leaky ReLU module 1036 of the block 1054 to produce a tensor 1038. The two tensors 1018, 1028 relate to the tensors 429, 469 respectively.

If PCA decoder method is used in the multi-scale feature decoder 1004, the input tensor 1002 includes eigen vectors and coefficients. The functional module 1004 is performed to restore the three tensors by the PCA algorithm. If the tensor L2 is upsampled before performing PCA encode, in the block 1004, a decoded PCA tensor is downsampled to recontruct a tensor L′2 having the same size with L2.

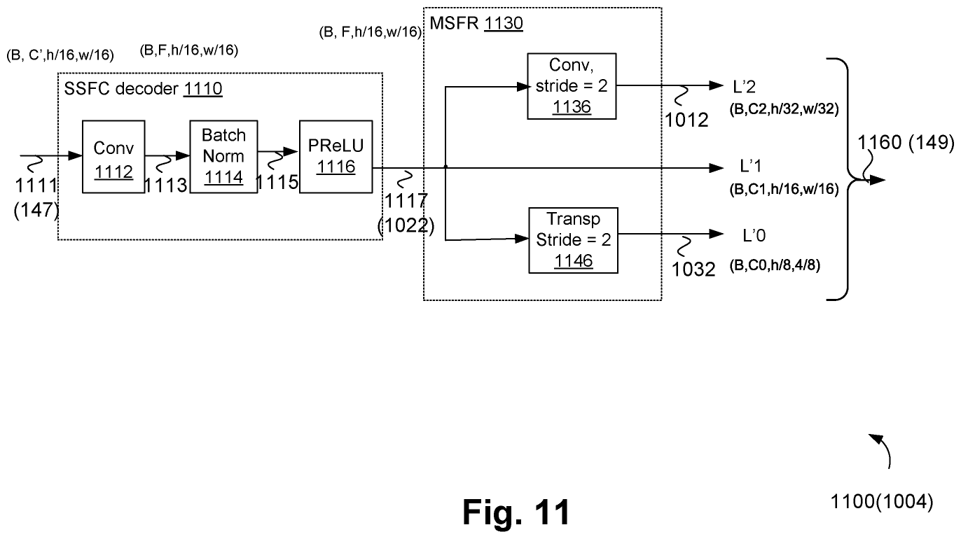

FIG. 11 is a schematic block diagram showing functional modules of a multi-scale feature decoder 1100, providing an implementation example of the multi-scale feature decoder 1004. The block 1100 contains two blocks: SSFC decoder 1110 and MSFR 1130. An input tensor 1111 relates to the output tensor 657 from the multiscale feature encoder 600 and corresponds to the unpack and inverse tensor 147. The tensor 1111 is input to the single scale feature compression SSFC decoder 1110. The tensor 1111 has the size of (B, C′, h/16, w/16) passes through a convolutional module 1112 to restore the number of channel F and produce a tensor 1113. The tensor 1113 has the size of (B, F, h/16,w/16). The tensor 1113 is passed through a batch-normalization 1114 to produce a tensor 1115. The size of the tensor 1115 is the same as the size of the tensor 1113. The tensor 1115 passes through an activation block PReLU 1116. The block 1116 implements an activation function such as PReLU or TanH, or Leaky ReLU.

The output of the block 1110 is a tensor 1117. The tensor 1117 is input to a multi-scale feature reconstruct MSFR 1130 to produce reconstructed tensors of the tensors L2, L1, and L0. The tensor 1117 may have the same spatial dimensions with the spatial dimensions of the tensor L2, the tensor 1117 corresponds to the reconstructed tensor L′1 (1022) of the tensor L1. To produce a tensor with a higher number of channels, and a smaller value of the spatial dimensions, a convolutional module with the value of stride is large than 1 can be used. The tensor L2 has the spatial size double in height and width compared with the spatial size of the tensor L1. A convolutional module 1136 with stride of 2 is used. The output of module 1136 is tensor 1012 L′2. The tensor L′2 has the same size as the size of L2.

To produce a tensor with a smaller number of channels, and a higher value of the spatial dimensions, a transpose (deconvolutional) module with the value of stride is large than 1 can be used. The tensor L0 has the spatial size of half in height and width compared with the spatial size of the tensor L1. A transpose module 1146 with stride of 2 is used. The output of module 1146 is tensor 1032 L′0. The tensor L′0 has the same size as the size of L0. Tensors 1160 are three tensors L′2, L′1, and L′0 that provide the tensor 149.

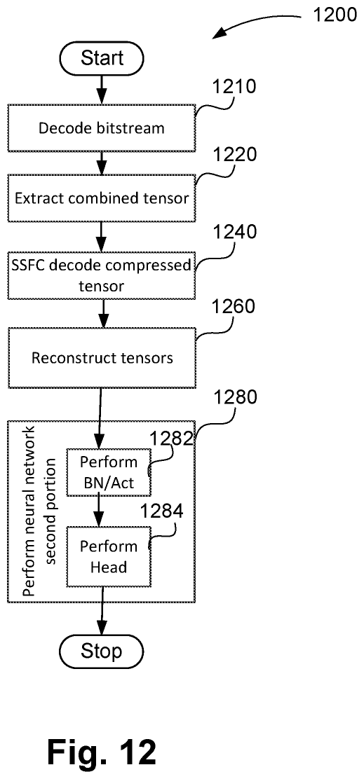

FIG. 12 shows a method 1200 for decoding a bitstream, reconstructing decorrelated feature maps, and performing a second portion of the CNN. The method 1200 may be implemented using apparatus such as a configured FPGA, an ASIC, or an ASSP. Alternatively, as described below, the method 1200 may be implemented by the destination device 140, as one or more software code modules of the application programs 233, under execution of the processor 205. The software code modules of the application programs 233 implementing the method 1200 may be resident, for example, in the hard disk drive 210 and/or the memory 206. The method 1200 is repeated for each frame of compressed data in the bitstream 143. The method 1200 may be stored on computer-readable storage medium and/or in the memory 206. The method 1200 beings at a decode bitstream step 1210.

At the step 1210, the feature decoder 144 receives the bitstream 143 relating to the image data encoded at the source device 110. The decoder 144 operates as described in relation to FIG. 9 to decode the frame 145 of packed data from the bitstream. The method 1200 continues under control of the processor 205 from step 1210 to an extract combined tensor step 1220.

At the step 1220 the unpack and inverse quantise module 146 extracts feature maps for the combined tensor, e.g., 657, from the decoded frame 145 and combines the feature maps to produce the output tensor 149. Each feature map is allocated to a different channel within the tensor 149. The extracted feature maps are inverse quantised from the integer domain to the floating-point domain at step 1220. The inverse quantised feature maps generated by operation of step 1220 are shown as tensor 1111 in FIG. 11. The method 1200 continues under control of the processor 205 with a progression from step 1220 to a SSFC decoding step 1220.

At the step 1240, an SSFC decoder 1130 is implemented under execution of the processor 205. The SSFC decoder performs neural network layers to decompress the decoded compressed tensor 1111 to produce the decoded combined tensor 1117 (the tensor 149). The convolutional layer 1112 receives the tensor 1111 having C′=64 channels and outputs the tensor 1113 having F=256 channels. The tensor 1113 is passed to the batch normalisation layer 1114. The batch normalisation layer outputs the tensor 1115. The tensor 1115 is passed to the parameterised leaky rectified linear (PReLU) layer 1116. The PReLU layer 1116 outputs the tensor 1117.

The steps 1240 and 1260 performing predetermined processing (implementing the bottleneck decoder 148) on each tensor decoded at step 1210 to derive each of the tensors 1012, 1022 and 1032. The tensors 1012, 1022 and 1032 correspond respectively to the tensors 429, 469 and 491 as generated by performing the convolutional modules (450, 460, 490) of a CBL module without performing the batch processing modules of each CBL. As described in relation to FIG. 11, tensors 1160 derived by operation of the MSFC decoder 150 have a smaller number of dimensions than the decoded tensors 147.

The method 1200 continues under control of the processor 205 from step 1240 to reconstruct tensors step 1260. At the step 1260 the multi-scale feature reconstruction (MSFR) module 1130, under execution of the processor 205, receives the tensor 1117 generated by operation of the step 1240. The step 1260 executes to produce the tensors L′2, L′1 and L′0, output as tensors 149, as described in relation to FIG. 11. The method 1200 continues under control of the processor 205 from step 1260 to a perform second neural network portion step 1260.

At the step 1280 the CNN head 1300 (150), under execution of the processor 205, receives the tensors 149 as input on which to perform the remainder of the neural network implemented by the system 100. The method 1200 terminates on implementing the step 1280, having processed tensors associated with one frame of video data. The method 1200 is re-invoked for each frame of video data encoded in the bitstream 143.

The step 1280 contains two main steps 1282 and 1284. At the first step 1282, the reconstructed tensors contain three tensors that may have different spatial resolutions. The first step 1282 thus performs a module sets of batch normalisation and Leaky ReLU (activation) for each of the tensor L′0, L′1 and L′0. The batch normalisation and Leaky ReLU modules belong to the three last CBL layers of three tracks in the skip connections stage. Batch normalisation and Leaky ReLU modules 1014, 1016, 1024, and 1026 corresponding to modules 452, 452, 462, and 464, respectively (with 452 and 454 as part of the CBL layer 428 and 462 and 464 as part of the CBL layer 468) need to be performed at the step 1282 to produce the tensor 1018 and the tensor 1028. The tensors 1018 and 1028 are supplied to the next stage of the head CNN 150. The batch normalisation and Leaky ReLU modules, that is, modules 1034 and 1036, that correspond to the CBL layer 488 only need to be performed in the head portion at the step 1282. Batch normalisation and Leaky ReLU stages of the CBL layer 488 do not need to be performed in the source device 110 since the split point is implemented at the output of convolution 490, that is, at tensor 491, and the output of the CBL layer 488 is not used within the skip connections 4004 as the layer 488 corresponds to the last FPN layer. The method 1200 continues under control of the processor 205 from step 1282 to a perform head step 1284. At the step 1284, the output of each Leaky ReLU modules performs a sequence of head layers to produce detection results and tracking results at different scales of input image or video frame.

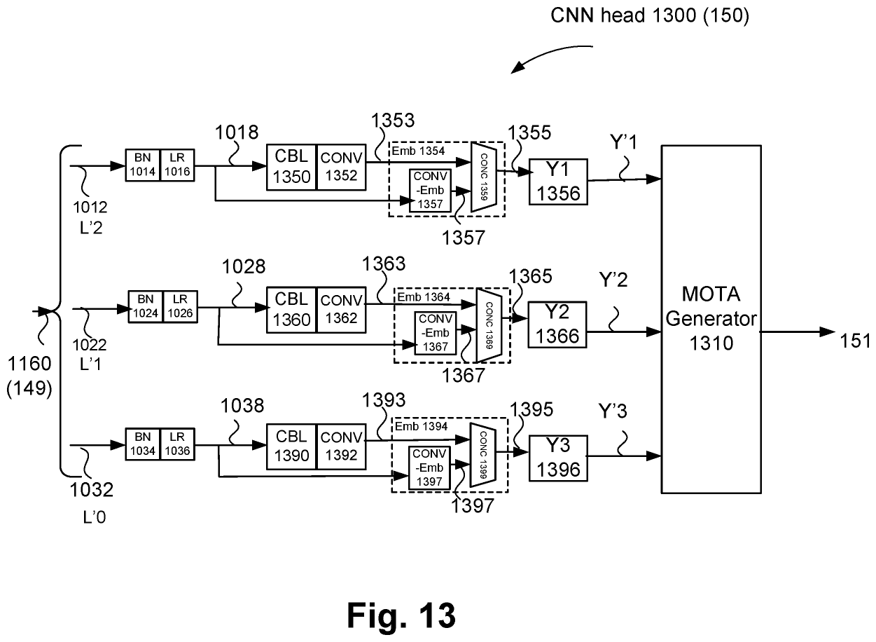

FIG. 13 is a schematic block diagram showing functional modules of a head portion 1300 of a CNN, which may serve as the CNN head 150. The portion 1300 is implemented in execution of the step 1280. The input tensors of the head are tensors 1160, corresponding to the tensors 149. The tensors 149 contain three tensors 1012 (L′2), 1022 (L′1), and 1032 (L′0).

The three tensors 1012, 1022, and 1032 are input to the CNN head 1300. Each tensor is input to a batch normalization module as the first module in the CNN head 150. The first tensor 1012 is input to a batch normalization 1014, then passes through a Leaky ReLU module 1016 to produce a tensor 1018 at step 1282. All following stages are implemented in execution of step 1284. The tensor 1018 passes through a CBL 1350, then a convolution module 1352 to produce a tensor 1353. An embedding block 1354 contains two modules, the first module being a convolution-embedding 1357 and the second module being a concatenator 1359. An ‘embedding’ process involves associating classes of detected objects in different frames, such as ‘person’ as being specific instances of each person. Embedding operates on the slices of the tensor where detected object is located and attempt to create an association based on similarity. Generally, a ‘size’ of an embedding refers to the number (and selection) of feature maps of the tensors used to generate this association. Using fewer feature maps to create the association reduces computational complexity while also reducing the ability to distinguish between different instances of the object. The embedding block 1354 takes the tensor 1018 as the input and outputs a tensor 1357 containing the number of channels equal to a size of embedding. In a tracking task, the size of embedding should be equal to or higher than the number of tracked objects. The concatenation block 1359 concatenates the two tensors 1353 and 1357 to produce a tensor 1355. The tensor 1355 is input to a head Y1 1356.

The second tensor 1022 is input to a batch normalization 1024, and the output passes through a Leaky ReLU module 1026 to produce a tensor 1028 at step 1282. All following stages are implemented in execution of step 1284. The tensor 1028 passes through a CBL 1360, then is input to convolution module 1362 to produce a tensor 1363. An embedding block 1364 contains two modules, the first module being a convolution-embedding 1367 and the second module being a concatenator 1369. The convolution-embedding 1367 takes the tensor 1028 as input and outputs a tensor 1367 containing the number of channels as equal to the size of the embedding. The concatenation block 1369 concatenates the two tensors 1363 and 1367 to produce a tensor 1365. The tensor 1365 is input to a head Y2 1366.

The third tensor 1032 is input to a batch normalization 1034, and the output passes through a Leaky ReLU module 1036 to produce the tensor 1038 at step 1282. As shown in FIG. 13, the head CNN 1300 performs the batch-normalization module of the CBL modules 428, 468 and 488 without performing the convolutional module of the CBL modules 428, 468 and 488.

All following stages are implemented in execution of step 1284. The tensor 1038 passes through a CBL 1390, then is input to a convolution module 1392 to produce a tensor 1393. An embedding block 1394 contains two modules, the first module being a convolution-embedding 1397 and the second module being a concatenator 1399. The convolution-embedding 1397 takes the tensor 1038 as the input and outputs a tensor 1397 containing the number of channels as equal to the size of the embedding. The concatenation block 1399 concatenates the two tensors 1393 and 1397 to produce a tensor 1395. The tensor 1395 is input to a head Y3 1396.

Each Yolo head Y1, Y2, and Y3 may contain the value of masks, anchors, and the number of classes. Each of the heads Y1 1356, Y2 1366 and Y3 1396 comprises a suitable YOLO network (for example YOLOv3 or YOLOv4) and operates to determining predictions (bounding boxes) Y′1, Y′2 and Y′3. The outputs Y′1, Y′2 and Y′3 are input to a MOTA generator 1310. The MOTA generator uses a threshold of some values such as IoU, NMS (Non Maximum Suppression) to make a decision that a detected box belongs to an object or not, and generate some tracking metrics such as MOTA, MOTP. The output of the generator 1310 provides the inferencing result 151.

As shown in FIG. 13 the neural network head 150 comprises a number of detection (CBL) blocks (1350, 1360 and 1390), each detection block followed by an output convolution block (1352, 1362, and 1392 respectively) and a head network, the first tensor being derived at a split point in the network before the detection blocks. The three detection blocks operate at resolutions and within each resolution detect objects with different receptive fields (or ‘anchors’) to detect objects at different ‘scales’. The output convolutional blocks flatten the output form the detection blocks and prepare for the final detection decision.

The arrangements described use the skip connections network having a split point at the outputs of convolutional layers in the CBL modules 428, 468 and 488. Resultantly, both the backbone 4001 and the head 1300 perform the batch normalization modules (452, 462) and Leaky ReLU (454, 464) modules from the CBL 428 layer and from the CBL 468 layer. FIG. 4 shows the backbone 4001 performs the 452 and 454 modules to produce the tensor 429, and performs 462 and 464 to produce the tensor 469. The tensors 429 and 469 are used for the next step in the skip connections stage. FIGS. 10 and 13 show the batch normalization modules and Leaky ReLU are performed again but in the head portion, to produces tensors 1018, 1028 that are used for the next step in the head portion.

Each convolutional module in the embedding block uses a linear function as the activation function. The output of these layers is the probability that each predicted box belongs to one of the objects need to be tracked or detected.

In another arrangement of the multi-scale feature encoder 600, tensors are downscaled to the spatial size of L2 tensor 451, as described with reference to FIGS. 14A and 14B.

FIG. 14A is a schematic block diagram 1400 showing an alternative multi-scale feature fusion module 1410. The MSFF module 1410 is used in place of the MSFF module 608 at the step 680 of the method 670. The module 1410 operates to reduce the spatial area of the tensors 629 to the spatial area of the L2 layer, that is, tensor 451. As a consequence, the spatial area of the tensor 117 (and thus each feature map 710) is also reduced to the spatial area of the tensor 451, thereby reducing the required area of the frame 700 and improving compression efficiency achieved by the feature map encoder 120. The L0 tensor 491 is passed to a downsample module 1422, which performs a four-to-one downsampling operation horizontally and vertically. The downsampling operation produces tensor 1423 having one sixteenth the area of the tensor 491. The downsample module 1422 may use methods such as decimation or filtering to perform the downsampling operation.

A downsample module 1420 performs a two-to-one downsampling operation horizontally and vertically on the L1 tensor 461 to produce tensor 1421 with one-quarter the area of the tensor 461, also using methods such as decimation or filtering. A concatenation module 1426 concatenates the tensors 451, 1421, and 1423 along the channel dimension to produce tensor 1428, having 128+256+512=896 channels, all at the width and height of the L2 tensor 451. The tensor 1428 is passed to a squeeze and excitation module 1430, which operates as described with reference to SE module 624 of FIG. 6 to produce a tensor 1432. A convolution module 1434 applies a convolution operation on the tensor 1432 to produce a tensor 1429, corresponding to the tensor 629. The tensor 1429 has F channels, where F is typically 256. The tensor 629 is passed to the SSFC encoder 650, with remaining operation for bottleneck encoding as described with reference to FIG. 6.

As a result of application of the MSFF 1410, smaller feature maps are produced and a smaller bitrate of the bitstream 121, while still retaining sufficient performance for the task of object tracking of people. In tracking people, the object detection of a JDE neural network needs to only recognise one object type, that is, ‘person’, and so a higher degree of compression in the bottleneck encoder and bottleneck decoder is possible without overly degrading task performance.

FIG. 14B is a schematic block diagram 1450 showing an alternative multi-scale feature reconstruction module 1460. The MSFR module 1460 is used as an alternative to the MSFR module 1130 and is used in conjunction with usage of the alternative MSFF module 1410 in the bottleneck encoder 116, operable at the reconstruct tensors step 1260 of the method 1200. Due to use of the alternative MSFF module 1410, the tensor 1117 has a width and height corresponding to the L2 layer tensor 451. The tensor 1117 is passed to a convolution module 1464 which produces L′2 tensor 1012 having 512 channels and the same width and height as the L2 layer tensor 451. The tensor 1117 is passed to a transpose convolution module 1462 to produce L′1 tensor 1022, with 256 channels and double the width and height of the tensor 1117. The transpose convolution 1462 operates as a convolution with a stride of a half for the module 1462, resulting in oversampling the tensor 1117. The module 1462 thus produces the tensor 1022 with a higher width and height than the tensor 1117. Transpose convolutions may also be referred to as ‘fractionally strided convolutions’ and may be trained to act as an inverse of an earlier-performed correlation that applied a stride of greater than one. The L′1 tensor 1022 is passed to a transpose convolutional module 1469, also with a stride of one half to produce L′0 tensor 1032, which has double the width and height of the L′1 tensor 1032 and 128 channels. Operation of the MSFR module 1460 results in reconstruction of the L0-L2 layers (the reconstructed versions identified as L′0-L′2), suitable for use by the CNN head 150.

FIG. 15A is a schematic block diagram showing an alternative bottleneck encoder 1500. In an arrangement of the source device 110 the bottleneck encoder 1500 is used in place of the bottleneck encoder 600. The bottleneck encoder 1500 provides for ‘dual scale’ operation whereby two compressed tensors, that is, tensors 657a and 657b are produced. The tensor 657b has twice the width and height of the tensor 657a and provides for higher fidelity in tasks requiring spatial detail, such as detection of people occupying a small portion of the frame 113. In applications where the video source 112 has a wide field of vision (for example, due to a high mounting point), the additional spatial detail afforded by the bottleneck encoder 1500 is beneficial.

The bottleneck encoder 1500 includes a multi-scale feature fusion module 1510. The L0 tensor 491 is passed to a downsample module 1530 which produces a tensor 1531 by halving the width and height of the tensor 491, such as by application of decimation of filtering. The L1 tensor 461 is passed to a downsample module 1512 which produces a tensor 1513 by halving the width and height of the tensor 461, also by use of techniques such as decimation or filtering. A concatenation module 1514 concatenates the L2 tensor 451 and the tensor 1513 along the channel dimension to produce a tensor 1515, having 768 channels. The tensor 1515 is passed to a squeeze-and-excitation module 1516, operable in accordance with the SE module 624 described with reference to FIG. 6, to produce a tensor 1517. The tensor 1517 is passed to a convolution module 1518 to produce a tensor 1519 as a first output from the MSFF module 1510, the tensor 1519 having 256 channels and the same width and height as the tensor 1517. A concatenation module 1532 concatenates the L1 tensor 461 and the tensor 1531 along the channel dimension to produce a tensor 1533 having 386 channels. The tensor 1533 is passed to a squeeze-and-excitation module 1534, operable in accordance with the SE module 624 as described with reference to FIG. 6, to produce a tensor 1535. The tensor 1535 is passed to a convolution module 1536 to produce a tensor 1537, having 256 channels and forming a second output of the MSFF module 1510.

The tensor 1519 is passed to an SSFC encoder module 1520 to produce a tensor 657a, having 64 channels. The tensor 1537 is passed to an SSFC encoder module 1540 to produce a tensor 657b, having 64 channels. The SSFC encoder modules 1520 and 1540 are each operable in accordance with the SSFC encoder 650 of FIG. 6.

In arrangements using the bottleneck encoder 1500 the step 680 of the method 670 is operable to perform the MSFF module 1510, that is, the modules 1512, 1530, 1514, 1532, 1516, 1518, 1534, and 1536. The step 684 of the method 670 is operable to perform the SSFC encoders 1520 and 1540, producing the tensors 657a and 657b. The step 688 of the method 670 is operable to quantise and pack both of the tensors 657a and 657b into separate non-overlapping regions of the frame 700.

FIG. 15B is a schematic block diagram showing an alternative bottleneck decoder 1550. The bottleneck decoder 1550 is used to reconstruct L0-L2 layers in an arrangement of the destination device 140 corresponding to an arrangement of the source device 110 in which compressed tensors were produced by the bottleneck encoder 1500. The decoder 1550 may be used instead of the decoder 1100 if the encoder 1500 was used by the source device 110. At the step 1220 of the method 1200, extraction and inverse quantisation of two tensors 147a and 147b from the frame 700 is performed, corresponding to the tensors 657a and 657b produced by the bottleneck encoder 1500. At the step 1240 an SSFC decoder 1560 decodes the tensor 1117a and produces a tensor 1562 having 256 channels. An SSFC decoder 1570 decodes the tensor 1117b and produces L′1 tensor 1022 having 256 channels. The SSFC decoders 1560 and 1570 are operable as described with reference to the SSFC decoder 1110 of FIG. 11.

A multi-scale feature reconstruction module 1580 produces L′0, L′1, and L′2 tensors, that is, 1032, 1022, and 1012, noting that the output of the SSFC decoder 1570 is directly supplied as output L′1 tensor 1022. The tensor 1562 is passed to a convolution module 1564 which produces L′2 tensor 1012 having 512 channels. The L′1 tensor 1022 is passed to a transpose convolution module 1572 which produces tensor L′0 1032, having twice the width and height of the tensor 1022 by virtue of using a fractional stride of one half. Application of the module 1580, that is, modules 1564 and 1572, is performed at the step 1260 of the method 1200. As a consequence of using the bottleneck encoder 1500 and the bottleneck decoder 1550, a greater degree of spatial detail is preserved in the tensors 1012, 1022, and 1032 with respect to 451, 461, and 491, improving the maximum achievable task performance for a task such as object tracking of people.

### Industrial Applicability

The arrangements described are applicable to the computer and data processing industries and particularly for the digital signal processing for the encoding and decoding of signals such as video and image signals, achieving high compression efficiency.

Ability to choose and encode different split points of a CNN into a bitstream allows flexibility of compression efficiency as a suitable split point can be identified for trade-offs between desired complexity, bitrate, and task performance. Further, if backbone neural networks are embedded in edge devices, efficiencies in encoding can also be realised. Complexity at a decoder side can be reduced and flexibility increased as different machine vision tasks can be implemented by different head CNNs. Reducing the tensor dimensions output by the backbone CNN through selection of split points can also increase efficiency at the decoder side. The arrangements described also allow different CNNs (for example YOLOv3, YOLOv4, or JDE) to be selected and the selection encoded in the bitstream, again allow increased options and flexibility. For example, selection of lower complexity CNN architectures such as YOLOv3, YOLOv4, and JDE, and selection of appropriate split points can make feature coding competitive with traditional coding solutions. Selecting the split point within a CBL module, being the output of a convolutional layer, provides additional benefits of decreasing complexity of computations (increasing competitiveness), as values that require feedback to the head (for example 429 and 469 can be accounted for without having to include the CBL blocks (such as 428, 468 and 488) in full in both the backbone and head networks). The arrangements described herein use and example of a YOLOv3 neural network. However, other types of neural networks, such as YOLOv4 and JDE networks can also be used.

The foregoing describes only some embodiments of the present invention, and modifications and/or changes can be made thereto without departing from the scope and spirit of the invention, the embodiments being illustrative and not restrictive.

1. A method of encoding a tensor related to image data into a bitstream, the method comprising:
acquiring a first tensor for the image data, the first tensor derived using a portion of a neural network, the neural network including at least a plurality of layers of a first type, each layer of the first type having at least a convolutional module and a batch-normalization module, wherein the first tensor corresponds to a tensor for which the convolutional module of one of the plurality of layers of the first type has been performed but for which the batch-normalization module of the one of the plurality of layers of the first type has not been performed;
performing predetermined processing on the first tensor to derive a second tensor, wherein the number of dimensions of a data structure of the first tensors is larger than the number of dimensions of a data structure of the second tensor; and
encoding the second tensor into the bitstream.

2. The method according to claim 1, wherein a last layer of the portion of the neural network includes the convolutional module.

3. The method according to claim 1, wherein the neural network further comprises a plurality of detection blocks, each of the detection blocks followed by an output convolution block and a head network, the first tensor being derived at a split point in the network before the detection blocks.

4. The method according to claim 1, wherein the first portion of the network includes a skip connections portion including three tracks, and the split points being in three last layers of the three tracks of the skip connections portion.

5. The method according to claim 1, wherein the neural network is a JDE network and the first tensor is generated using a split point from each of a layer 79 of the neural network, a layer 94 of the neural network and a layer 109 of the neural network.

6. The method according to claim 1, wherein the neural network is a JDE network,—the first type of layer is a convolutional batch normalisation leaky rectified linear (CBL) layer and the first tensor is generated using a split point following the convolution layer at CBL layers for each of the layers 79, 94 and 109 of the network.

7. A method of deriving a tensor based on a bitstream related to image data, the derived tensor being for processing using a portion of a neural network, the method comprising:
decoding a tensor from the bitstream; and
performing predetermined processing on the decoded tensor to generate the derived tensor, a number of dimensions of a data structure of the derived tensor being larger than a number of dimensions of a data structure of the decoded tensor; wherein
the neural network includes at least a plurality of layers of a first type, each layer of the first type having at least a convolutional module and a batch-normalization module, and
the derived tensor corresponds to a tensor in which a processing of the convolutional module of one of the plurality of layers of the first type has been performed but a processing of the batch-normalization module of the one of the plurality of layers of the first type has not been performed.

8. The method according to claim 7, further comprising:
performing, by the portion of the neural network on the derived tensor, the batch-normalization module of the one of the plurality of layers of the first type without performing the convolutional module of the one of the plurality of layers.

9. The method according to claim 7, wherein two first layers of the portion of the neural network include one batch normalization and one activation function corresponding to the one of the plurality of layers of the first type.

10. The method according to claim 7, wherein the portion of the neural network comprises a plurality of detection blocks followed by an output convolution block, an embedding block and a head network, the-first tensor being generated at a split point in the neural network before the detection blocks.

11. The method according to claim 10, wherein the neural network further includes a skip connections portion, the split point being in three last layers of the three tracks of the skip connections portion.

12. The method according to claim 7, further comprising, inputting the derived tensor to the portion of the neural network, the portion of the neural network generating a result of a machine task.

13. A non-transitory computer-readable storage medium which stores a program for executing a method of encoding a tensor related to image data into a bitstream, the method comprising:
acquiring a first tensor for the image data, the first tensor derived using a portion of a neural network, the neural network including at least a plurality of layers of a first type, a layer of the first type having at least a convolutional module and a batch-normalization module, wherein the first tensor corresponds to a tensor for which the convolutional module of one of the plurality of layers of the first type has been performed but for which the batch-normalization module of the one of the plurality of layers of the first type has not been performed;
performing predetermined processing on the first tensor to derive a second tensor, wherein the number of dimensions of a data structure of the first tensors is larger than the number of dimensions of a data structure of the second tensor; and
encoding the second tensor into the bitstream.

14. An encoder configured to:
acquire a first tensor related to image data, the first tensor derived using a portion of a neural network, the neural network including at least a plurality of layers of a first type, a layer of the first type having at least a convolutional module and a batch-normalization module, wherein the first tensor corresponds to a tensor for which the convolutional module of one of the plurality of layers of the first type has been performed but for which the batch-normalization module of the one of the plurality of layers of the first type has not been performed;
perform predetermined processing on the first tensor to derive a second tensor, wherein the number of dimensions of a data structure of the first tensors is larger than the number of dimensions of a data structure of the second tensor; and
encode the second tensor into the bitstream.

15. A system comprising:
a memory; and
a processor, wherein the processor is configured to execute code stored on the memory for implementing a method of encoding a tensor related to image data into a bitstream, the method comprising:
acquiring a first tensor for the image data, the first tensor derived using a portion of a neural network, the neural network including at least a plurality of layers of a first type, a layer of the first type having at least a convolutional module and a batch-normalization module, wherein the first tensor corresponds to a tensor for which the convolutional module of one of the plurality of layers of the first type has been performed but for which the batch-normalization module of the one of the plurality of layers of the first type has not been performed;
performing predetermined processing on the first tensor to derive a second tensor, wherein the number of dimensions of a data structure of the first tensors is larger than the number of dimensions of a data structure of the second tensor; and
encoding the second tensor into the bitstream.

16. A non-transitory computer-readable storage medium which stores a program for executing a method of deriving a tensor based on a bitstream related to image data, the derived tensor being for processing using a portion of a neural network, the method comprising:
decoding a tensor from the bitstream; and
performing predetermined processing on the decoded tensor to generate the derived tensor, a number of dimensions of a data structure of the derived tensor being larger than a number of dimensions of a data structure of the decoded tensor; wherein
the neural network includes at least a plurality of layers of a first type, ah layer of the first type having at least a convolutional module and a batch-normalization module, and
the derived tensor corresponds to a tensor in which a processing of the convolutional module of one of the plurality of layers of the first type has been performed but a processing of the batch-normalization module of the one of the plurality of layers of the first type has not been performed.

17. A decoder configured to:
decode a tensor from a bitstream related to image data; and
perform predetermined processing on the decoded tensor to generate a derived tensor for processing using a portion of a neural network, a number of dimensions of a data structure of the derived tensor being larger than a number of dimensions of a data structure of the decoded tensor; wherein
the neural network includes at least a plurality of layers of a first type, a layer of the first type having at least a convolutional module and a batch-normalization module, and
the derived tensor corresponds to a tensor in which a processing of the convolutional module of one of the plurality of layers of the first type has been performed but a processing of the batch-normalization module of the one of the plurality of layers of the first type has not been performed.

18. A system comprising:
a memory; and
a processor, wherein the processor is configured to execute code stored on the memory for implementing a method of deriving a tensor based on a bitstream related to image data, the derived tensor being for processing using a portion of a neural network, the method comprising:
decoding a tensor from the bitstream; and
performing predetermined processing on the decoded tensor to generate the derived tensor, a number of dimensions of a data structure of the derived tensor being larger than a number of dimensions of a data structure of the decoded tensor; wherein
the neural network includes at least a plurality of layers of a first type, a layer of the first type having at least a convolutional module and a batch-normalization module, and
the derived tensor corresponds to a tensor in which a processing of the convolutional module of one of the plurality of layers of the first type has been performed but a processing of the batch-normalization module of the one of the plurality of layers of the first type has not been performed.
